(19) United States
(12) Patent Application Publication
(10) Pub. No.: US 2026/0317185 A1
(43) Pub. Date: Oct. 15, 2026

(54) DIRECT HYDROGEN CYANIDE (HCN) SYNTHESIS VIA PLASMA-ASSISTED CONVERSION OF METHANE AND NITROGEN

(71) Applicant: University of Delaware, Newark, DE (US)

(72) Inventors: Nefeli Kamarinopoulou, Newark, DE (US); Dionisios G. Vlachos, Newark, DE (US)

(73) Assignee: University of Delaware, Newark, DE (US)

(21) Appl. No.: 19/490,855

(22) PCT Filed: Jun. 6, 2024
(86) PCT No.: PCT/US2024/032740

§ 371 Date: Dec. 5, 2025

Related U.S. Application Data
(60) Provisional application No. 63/506,647, filed on Jun. 7, 2023.

(51) Int. Cl. C01C 3/02; B01J 19/08

(52) U.S. Cl. CPC C01C 3/025; B01J 19/088; B01J 2219/0883; B01J 2219/0894

(57) ABSTRACT

Disclosed herein are processes that can directly synthesize hydrogen cyanide from methane and nitrogen in a single-step conversion. Systems for performing the process are also disclosed.

### CROSS-REFERENCE TO RELATED APPLICATION

This application claims priority to U.S. Provisional Application No. 63/506,647, filed Jun. 7, 2023, and the contents of which are incorporated herein by reference in their entireties for all purposes.

### FIELD

The present disclosure relates to a process that can directly synthesize hydrogen cyanide from methane and nitrogen in a single-step conversion. Systems for performing the process are also disclosed.

### BACKGROUND

About 1.1 million metric tons of hydrogen cyanide (HCN) are produced annually accounting for about 0.3% of ammonia's market size. HCN is a platform chemical primarily used in producing methyl methacrylate and adiponitrile, precursors to PMMA and Nylon, respectively. HCN can be produced via the Andrussow (2CH₄+2NH₃+3O₂→2HCN+6H₂O) or Degussa (CH₄+NH₃→HCN+34H₂) processes in conventionally heated reactors, or the more recent Invista induction-heated reactor. These reactions occur over a Pt gauge catalyst at high operating temperatures (>1000° C.) to achieve high HCN selectivity (>60%) and requires the use of an ammonia feedstock.

Ammonia (NH₃) is central to the United States' current economy. It is primarily used for fertilizers supporting population growth and improved quality of life and producing chemicals, such as hydrogen cyanide (HCN). The infrastructure for large-scale ammonia synthesis, however, is multistep, complex, energy and carbon-intensive and is incompatible with remote smaller-scale processing. For example, ammonia's production from hydrogen (H₂) and nitrogen (N₂) via the Haber-Bosch process requires multiple upstream energy-intensive steps (e.g., methane steam reforming, water gas-shift, H₂ purification, and cryogenic air separation). Ammonia synthesis also contributes to high CO₂ emissions due to the H₂ compression and its equilibrium limitations leading to low conversions and separation for recycling the reactants. The high operating temperatures of these conventional NH₃ and HCN production processes, along with their high CO₂ emissions, are problematic due to the economic burden they can place on manufactures and their contribution to the accumulation of greenhouse gases.

Thus, to address the foregoing issues, processes and systems that are capable of synthesizing HCN from nitrogen and methane in a catalyst-free single-step plasma-assisted conversion are disclosed herein.

### SUMMARY

Disclosed herein is a method for synthesizing hydrogen cyanide including (i.e., comprising) one or more of: generating a plasma discharge zone inside a dielectric barrier discharge (DBD) reactor; wherein the DBD reactor does not contain a catalyst; adding a gas mixture containing methane gas and nitrogen gas into the DBD reactor; dissociating the methane gas into methyl radicals and the nitrogen gas into nitrogen radicals in the reaction zone of the DBD reactor; and synthesizing hydrogen cyanide from the methyl radicals and the nitrogen radicals in the reaction zone of the DBD reactor.

Also disclosed herein is a system for synthesizing hydrogen cyanide including one or more of: a first storage compartment configured to store nitrogen gas; a second storage compartment configured to store a gas mixture containing methane gas and nitrogen gas; a mixer configured to receive and mix together a stream of nitrogen gas from the first storage compartment and a stream of the gas mixture from the second storage compartment; and a plasma reactor in communication with the mixer.

### BRIEF DESCRIPTION OF THE DRAWINGS

Other features and advantages of the compositions, devices and methods disclosed herein will be apparent to those skilled in the art reading the following detailed description in conjugation with the exemplary embodiments illustrated in the drawings, wherein:

FIG. 1 depicts discharge voltages and current waveforms for an exemplary DBD plasma assisted HCN synthesis that includes the following experimental conditions: 1% feed CH₄ concentration, 99% feed N₂ concentration, 0.47 s residence time, 28.6 W discharge power, and 22 kHz AC voltage frequency.

FIG. 2 depicts the effect that CH₄ feed concentration has on the selectivities of various products from exemplary HCN synthesis processes. The various products are HCN, C₂H₆ and other C-products (C₂H₂, C₂H₄, C₃H₈, CH₃CN, C₄ hydrocarbons, propionitrile (CH₃CH₂CN) and acrylonitrile (CH₂CHCN)) and aromatics/coke. CH₄ conversion (grey curve) and energy consumption, E_{HCN} (black curve), are also depicted. Triplicates were conducted for 0.1, 0.5, 2 and 7% C_{CH}_{₄}_{,0}; the displayed yield and conversion values are the average. The standard deviation for the remaining conditions was set equal to the highest value. Experimental conditions: 0.47 s residence time, 28.1 W average discharge power, 22 kHz AC voltage frequency.

FIG. 3 depicts the effect of CH₄ feed fraction on the hydrogen-based selectivity of HCN, C₂H₆, other C-products (C₂H₂, C₂H₄, C₃H₆, C₃H₈, acetonitrile (CH₃CN), C₄ hydrocarbons, propionitrile (CH₃CH₂CN) and acrylonitrile (CH₂CHCN)) and hydrogen for an exemplary HCN synthesis process.

FIG. 4 depicts gas chromatograms for an exemplary HCN synthesis process involving dielectric barrier discharge plasma-assisted conversion of CH₄ and N₂. The y-axis represents absolute intensity in pA and the x-axis elution time (ET) in min. Top gas chromatogram: FID signal, bottom gas chromatogram: TCD signal. Products observed with FID depicted from left to right: CH₄ (ET=0.674), C₂H₄ (ET=1.2), C₂H₂ (ET=1.329), C₂H₆ (ET=1.5), C₃H₆ (ET=3.78), C₃H₈ (ET=4.028), HCN (ET=4.762), C₄ HCs (ET=6.2-6.75), CH₃CN (ET=7.493), CH₂CHCN (ET=8.556), CH₃CH₂CN (ET=9.525), C₆H₆ (ET=10.841). Experimental conditions: 1% feed CH₄ concentration, 99% feed N₂ concentration, 0.47 s residence time, 28.6 W discharge power, 22 kHz AC voltage frequency. Products observed with TCD depicted from left to right: H₂ (ET=1.785), N₂ (ET=2.596), CH₄ (ET=3.152).

FIG. 5 depicts the FID signal of a NH₃ standard gas chromatogram. The y-axis represents absolute intensity in pA and the x-axis elution time (ET) in min. The elution time for NH₃ is 1.489 min. Standard concentration: 10% NH₃, 90% N₂.

FIG. 6 depicts the carbon balance (%), hydrogen balance (%) and discharge power (W) with increasing feed CH₄ concentration (%) for an exemplary HCN synthesis process. The average power is evaluated about 28.1 W. Experimental conditions: 0.47 s residence time, 22 kHz AC voltage frequency.

FIG. 7 depicts a comparison of thermodynamic yields of HCN and C₂H₆ for an exemplary HCN synthesis process at 282° C. and 1 atm with increasing CH₄ feed fraction, as predicted by an equilibrium model, with experimental yields of HCN and C₂H₆ produced by the N₂/CH₄ DBD plasma at the same conditions.

FIG. 8 depicts the average reaction temperature profile (° C.) of an exemplary HCN synthesis process with continuous plasma operation time (s) across varying feed CH₄ concentrations (0.1-7%).

FIG. 9 depicts the reduced electric fields, E/N, (Td) of an exemplary HCN synthesis process with increasing feed CH₄ concentrations (%). The average E/N is equal to about 189 Td. Experimental conditions: 0.47 s residence time, 22 kHz AC voltage frequency.

FIG. 10 depicts the effect of plasma residence time on product distribution, CH₄ conversion, and E_{HCN} for an exemplary HCN synthesis process. Triplicates were conducted for all conditions; the displayed selectivity and conversion values are the average. Experimental conditions: 1% feed CH₄ fraction, 28.1 W average discharge power, 22 kHz AC voltage frequency.

FIG. 11 depicts the carbon balance (%), hydrogen balance (%) and discharge power (W) of an exemplary HCN synthesis process with decreasing plasma residence time (s). Experimental conditions: 1% feed CH₄ concentration, 99% feed N₂ concentration, 22 kHz AC voltage frequency. The average power is evaluated about 28.1 W.

FIG. 12 depicts the reduced electric fields, E/N, (Td) of an exemplary HCN synthesis process with decreasing plasma residence times (s). The average E/N is equal to about 184 Td. Experimental conditions: 1% feed CH₄ concentration, 99% feed N₂ concentration, 22 kHz AC voltage frequency.

FIG. 13 depicts the effect of discharge power on product distribution, CH₄ conversion and E_{HCN} for an exemplary HCN synthesis process. Experimental conditions: 1% feed CH₄ concentration, 99% feed N₂ concentration, 0.47 s residence time, 22 kHz AC voltage frequency.

FIG. 14 depicts the stability of HCN yield with time on stream for an exemplary HCN synthesis process. Experimental conditions: 0.3% feed CH₄ concentration, 99.7% feed N₂ concentration, 0.47 s residence time, 22 kHz AC voltage frequency, 28 W discharge power.

FIG. 15 depicts the results of a parametric study on a MKM model. The study examined the effect that various reduced electric fields have on the MKM model's product distribution and CH₄ conversion. The results of the MKM model simulations were compared with actual experimental data gathered from an exemplary HCN synthesis process. (A) MKM model simulation where E/N=150 Td and residence time=4.69 ms. (B) MKM model simulation where E/N=300 Td and residence time=1.26 ms. (C) MKM model simulation where E/N=500 Td and residence time=0.24 ms. (D) Experimental data on product distribution and CH₄ conversion for the exemplary HCN synthesis process at a feed concentration range of 0.1-7%. MKM conditions: 10¹¹ cm⁻³ nₑ, 550 K gas temperature.

FIG. 16 depicts the results of a parametric study on a MKM model. The study examined the effect that various electron densities have on the MKM model's product distribution and CH₄ conversion. (A) MKM model simulation where nₑ=10⁹ cm⁻³ and residence time=18 ms. (B) MKM model simulation where nₑ=10¹⁰ cm⁻³ and residence time=4.2 ms. (C) MKM model simulation where nₑ=10¹¹ cm⁻³ and residence time=1.26 ms. (D) MKM model simulation where nₑ=10¹³ cm⁻³ and residence time=0.015 ms. MKM conditions: 300 Td E/N, 550 K gas temperature.

FIG. 17 depicts the results of a parametric study on a MKM model. The study examined the effect that various T_{g} temperatures (i.e., gas temperatures) have on the MKM model's product distribution and CH₄ conversion. (A) MKM model simulation where T_{g}=450 K and residence time=1.2 ms. (B) MKM model simulation where T_{g}=550 K and residence time=1.02 ms. (C) MKM model simulation where T_{g}=600 K and residence time=0.48 ms. (D) MKM model simulation where T_{g}=700 K and residence time=0.285 ms. MKM conditions: 300 Td E/N, 10¹¹ cm⁻³ nₑ.

FIG. 18 depicts the ratio of N₂⁺ (B-X, 0-0) and N₂ (C-B, 0-0) emissions for an exemplary HCN synthesis process evaluated for reduced electric field values of 100-500 Td at P=1 atm and T=550 K over a range of electron densities (10⁹-10¹⁵ cm⁻³). The dashed line corresponds to the measured ratio of N₂ intensities (3.47×10⁻³) for experimental conditions: 1% feed CH₄ concentration, 99% feed N₂ concentration, 0.47 s residence time, 28.6 W discharge power, 22 kHz AC voltage frequency.

FIG. 19 depicts the effect of CH₄ feed fraction on HCN, C₂H₆ and other product yields for an exemplary HCN synthesis process. CH₄ conversion is also displayed.

FIG. 20 depicts the effect of CH₄ feed fraction on HCN, C₂H₆ and other product yields for an exemplary HCN synthesis process, as predicted by an MKM. CH₄ conversion is also displayed.

FIG. 21 depicts the HCN yield parity plot for an exemplary HCN synthesis process with methane feed fractions of 0.1-7%, as predicted by an MKM. Methane feed concentration decreases with increasing HCN yield. MKM conditions: 300 Td E/N, 10¹¹ cm⁻³ nₑ, 550 K gas temperature, 1.26 ms residence time.

FIG. 22 depicts the evolution of CH₄ conversion with residence time for different CH₄ feed fractions for an exemplary HCN synthesis process, as predicted by an MKM. The marked data points at 3 ms correspond to the experimental measurements. The darkest to lightest shades represent the lowest to highest CH₄ feed fraction, respectively. MKM conditions: 300 Td E/N, 10¹¹ cm⁻³ nₑ, 550 K gas temperature.

FIG. 23 depicts the evolution of HCN yield with residence time for different CH₄ feed fractions of an exemplary HCN synthesis process, as predicted by an MKM. The marked data points at 3 ms correspond to the experimental measurements. The darkest to lightest shades represent the lowest to highest CH₄ feed fraction, respectively. MKM conditions: 300 Td E/N, 10¹¹ cm⁻³ nₑ, 550 K gas temperature.

FIG. 24 depicts the evolution of C₂H₆ yield with residence time for different CH₄ feed fractions for an exemplary HCN synthesis process, as predicted by an MKM. The marked data points at 3 ms correspond to the experimental measurements. The darkest to lightest shades represent the lowest to highest CH₄ feed fraction, respectively. MKM conditions: 300 Td E/N, 10¹¹ cm⁻³ nₑ, 550 K gas temperature.

FIG. 25 depicts the evolution of HCN yield with residence time for an exemplary HCN synthesis process, as predicted by an MKM. MKM conditions: 1% feed CH₄ concentration, 300 Td E/N, 10¹¹ cm⁻³ nₑ, 550 K gas temperature, 0.25 ms discretization.

FIG. 26 depicts the evolution of HCN yield with residence time for different feed CH₄ concentrations (0.1-7%) for an exemplary HCN synthesis process, as predicted by an MKM. MKM conditions: 300 Td E/N, 10¹¹ cm⁻³ nₑ, 550 K gas temperature, 0.25 ms discretization.

FIG. 27 depicts a reaction path analysis (RPA) for an exemplary plasma assisted HCN synthesis from CH₄/N₂. H₂ fluxes are implicitly included. CH₂(T) is the triplet CH₂ radical. Dark grey arrows correspond to electron impact reactions. Light grey arrows correspond to non-equilibrated thermal reactions. Dashed arrows correspond to equilibrated thermal reactions. The percentage fluxes are normalized based on CH₄ inflow to the CSTR node (e.g., 27000% flux of N₂ to ·N indicates that this conversion occurs 27000 faster than the inflow of methane) and are represented by the thickness of the arrows. Reaction conditions: 300 Td E/N, 10¹¹ cm⁻³ nₑ, 550 K gas temperature, 1.26 ms residence time, and 0.1% CH₄ feed fraction (rates above 10⁻⁷ and

$$2.3 \times {10}^{- 5} \frac{mol}{s} ,$$

respectively, are displayed for clarity; the CH₄ inflow rate at 1.26 ms is 2×10⁻⁶ and

$$3.4 \times 1 {0}^{- 4} \frac{mol}{s} ,$$

respectively).

FIG. 28 depicts a reaction path analysis (RPA) for an exemplary plasma assisted HCN synthesis from CH₄/N₂. H₂ fluxes are implicitly included. CH₂(T) is the triplet CH₂ radical. Dark grey arrows correspond to electron impact reactions. Light grey arrows correspond to non-equilibrated thermal reactions. Dashed arrows correspond to equilibrated thermal reactions. The percentage fluxes are normalized based on CH₄ inflow to the CSTR node (e.g., 27000% flux of N₂ to ·N indicates that this conversion occurs 27000 faster than the inflow of methane) and are represented by the thickness of the arrows. Reaction conditions: 300 Td E/N, 10¹¹ cm⁻³ nₑ, 550 K gas temperature, 1.26 ms residence time, and 7.0% CH₄ feed fraction (rates above 10⁻⁷ and

$$2.3 \times 1 {0}^{- 5} \frac{mol}{s} ,$$

respectively, are displayed for clarity; the CH₄ inflow rate at 1.26 ms is 2×10⁻⁶ and

$$3.4 \times 1 {0}^{- 4} \frac{mol}{s} ,$$

respectively).

FIG. 29 depicts the crucial intermediates in an exemplary CH₄/N₂ plasma assisted HCN synthesis process. Effect of various CH₄ feed fractions (0.1, 2 and 7%) on reaction paths are displayed. The percentages on the arrows correspond to the normalized contribution of each reaction based on CH₄ inflow to the production of HCN. Conditions: 300 Td E/N, 10¹¹ cm⁻³ nₑ, 550 K gas temperature, 1.26 ms residence time.

FIG. 30 depicts predicted HCN yields of an exemplary HCN synthesis process with various residence times for different operating conditions. Variable P=0.001-1 atm at 50% feed CH₄ concentration, E/N=300 Td, nₑ=10¹ cm⁻³ and T=550 K.

FIG. 31 depicts a performance comparison of an exemplary HCN synthesis process with other plasma and industrial processes. Energy consumption, E_{HCN} (kJ/mmol HCN) and CO₂ equivalent emissions (kg CO₂/kg HCN) of the exemplary process, reported industrial and plasma processes are displayed.

FIG. 32 depicts a schematic of an exemplary system configured to perform a CH₄/N₂ plasma assisted HCN synthesis process.

FIG. 33 depicts an optical emission spectra of an exemplary sinusoidal CH₄/N₂ DBD. X represents an electronically excited ground state, while B and C represent electronically excited states. The numbers refer to the specific vibrational state transition. Experimental conditions: 1% feed CH₄ concentration, 99% feed N₂ concentration, 0.47 s residence time, 28.6 W discharge power, 22 kHz AC voltage frequency. The vibrational bands of the second N₂ positive system, N₂ (C-B), that of the first negative system N₂+(B-X, 0-0) at 391 nm, as well as the vibrational bands of CN* and CH* are observed.

FIG. 34 depicts an average reaction temperature profile (° C.) with continuous plasma operation time (s), as measured by an optical fiber, for an exemplary HCN synthesis process involving dielectric barrier discharge plasma-assisted conversion of CH₄ and N₂. Experimental conditions: 1% feed CH₄ concentration, 99% feed N₂ concentration, 0.47 s residence time, 28.6 W discharge power, 22 kHz AC voltage frequency. The temperature at the beginning of this experiment was 26.2° C. The average reaction temperature was evaluated at about 282° C.

FIG. 35 depicts the residual values around the average gas temperature for the exemplary HCN synthesis process of FIG. 34 around an average temperature of 282° C. for t≥14.5 min.

FIG. 36 depicts a graphical comparison of the computational tools and mathematical equations used in a plasma modelling approach (top) to existing methods (bottom). Bold text enclosures below software names represent inputs (grey filled text) and mathematical operations conducted by the software.

FIG. 37 depicts a temperature profile of a HV electrode with continuous plasma exposure time, as measured by the IR camera. Experimental conditions: 0.1% feed CH₄ concentration, 99.9% feed N₂ concentration, 0.47 s residence time, 25.2 W discharge power, 22 kHz AC voltage frequency. The temperature at the beginning of the experiment was 28.4° C.

FIG. 38 depicts a vacuum pressure swing adsorption (VPSA) scheme for HCN recovery from a dilute product stream of an exemplary N₂/CH₄ DBD plasma reactor. HCN adsorption occurs at ambient temperature (293 K) and pressure (1 bar) (column on the left) and desorption at 10⁻⁵ bar and 293 K (column on the right).

FIG. 39 depicts an Edwards EDS480 vacuum pump down graph for 980 L of gas; y-axis: chamber pressure in mbar, x-axis: required time for a 980 L chamber to reach corresponding pressure in s.

FIG. 40 depicts an Edwards EDS480 vacuum pump power consumption-evacuation time graph for 980 L of gas.

### DETAILED DESCRIPTION

One aspect of the present disclosure is a method for synthesizing hydrogen cyanide including one or more of: generating a plasma discharge zone inside a dielectric barrier discharge (DBD) reactor; wherein the DBD reactor does not contain a catalyst; adding a gas mixture containing methane gas and nitrogen gas into the DBD reactor; dissociating the methane gas into methyl radicals and the nitrogen gas into nitrogen radicals in the reaction zone of the DBD reactor; and synthesizing hydrogen cyanide from the methyl radicals and the nitrogen radicals in the reaction zone of the DBD reactor.

As used herein, a “plasma discharge zone” is an area in a reactor (e.g., a DBD reactor) located between two electrodes that is capable of generating a plasma discharge.

In exemplary embodiments, the generating of the plasma discharge zone inside the DBD reactor includes generating a frequency with an alternating current (AC) power supply between a high voltage electrode and a grounding electrode. In exemplary embodiments, the AC power supply generates a frequency of 22 kHz. In exemplary embodiments, the AC power supply generates any frequency or frequency range falling with the range of 15 to 30 kHz.

In exemplary embodiments, the generating of the plasma discharge zone inside the DBD reactor includes generating a discharge power with an AC power supply. In exemplary embodiments, the AC power supply generates a discharge power ranging from 20 to 60 W, 20 to 50 W, 20 to 40 W, 25 to 40 W or any range falling within 20 to 60 W. In exemplary embodiments, the AC power supply generates any discharge power falling within the range of 20 to 60 W.

In exemplary embodiments, the gas mixture containing methane gas and nitrogen gas is premixed with a nitrogen gas containing at least 95% N₂ before being added into the reaction zone of the DBD reactor. In exemplary embodiments, the gas mixture containing methane gas and nitrogen gas is premixed with a nitrogen gas containing 99.99% N₂ before being added into the reaction zone of the DBD reactor.

In exemplary embodiments, the forming of hydrogen cyanide gas from the methyl radicals and the nitrogen radicals in the plasma discharge zone inside the DBD reactor occurs at a temperature ranging from 25° C. to 300° C., 50° C. to 300° C., 100° C. to 300° C., 150° C. to 300° C., 200° C. to 300° C., 250° C. to 300° C., 280° C. to 300° C., any temperature range falling with the range of 25° C. to 300° C. or any temperature falling within the range of 25° C. to 300° C. In exemplary embodiments, the forming of hydrogen cyanide gas from the methyl radicals and the nitrogen radicals in the plasma discharge zone inside the DBD reactor occurs at about 282° C.

As used herein, the term “about” refers to a value that is ±5% of the stated value. In addition, it is understood that reference to a range of a first value to a second value includes the range of the stated values, e.g., a range of about 1 to about 5 also includes the more precise range of 1 to 5. It is also understood that the ranges disclosed herein include any selected subrange within the stated range, e.g., a subrange of about 50 to about 60 is contemplated in a disclosed range of about 1 to about 100.

In exemplary embodiments, the gas mixture containing methane gas and nitrogen gas possesses methane at a concentration ranging from 0.1 to 7.0 wt %, 0.1 to 5.0 wt %, 0.1 to 4.0 wt %, 0.1 to 3.0 wt %, 0.1 to 2.0 wt % or 0.1 to 1.0 wt %, based on the total weight of the gas mixture. In exemplary embodiments, the gas mixture containing methane gas and nitrogen gas possesses methane at any concentration falling within the range of 0.1 to 7.0 wt %. In exemplary embodiments, the gas mixture containing methane gas and nitrogen gas possesses methane at any range falling within the range of 0.1 to 7.0 wt %.

In exemplary embodiments, the gas mixture containing methane gas and nitrogen gas resides in the plasma discharge zone of the DBD reactor for a time ranging from 0.1 to 1.9 seconds, 0.2 to 1.9 seconds, 0.3 to 1.9 seconds, 0.4 to 1.9 seconds, 0.5 to 1.9 seconds, 1.0 to 1.9 seconds, or 1.5 to 1.9 seconds. In exemplary embodiments, the gas mixture containing methane gas and nitrogen gas resides in the plasma discharge zone of the DBD reactor for any time falling within the range of 0.1 to 1.9 seconds. In exemplary embodiments, the gas mixture containing methane gas and nitrogen gas resides in the plasma discharge zone of the DBD reactor for any time range falling within the range of 0.1 to 1.9 seconds.

In exemplary embodiments, the dissociating of the methane gas into methyl radicals includes forming one or more intermediate methyl radical species selected from, but not limited to, ·CH₃ and/or ·CH₂.

In exemplary embodiments, the dissociating of the nitrogen gas into nitrogen radicals includes forming one or more intermediate nitrogen radical species selected from, but not limited to, ·N, ·NH, ·HCNH and/or ·H₂CN.

In exemplary embodiments, the generating of the plasma discharge inside the reaction zone of the DBD reactor includes one or more of the following: generating a reduced electric field of 150-500 Td, 200-500 Td, 300-500 Td, 400-500 Td, 300 Td, or any reduced electric field or range of reduced electric fields falling within the range of 150-500 Td in the plasma discharge zone; generating a discharge power of 25 to 60 W, 25 to 50 W, 25 to 40 W or any discharge power or range of discharge power falling within the range of 25 to 60 W in the plasma discharge zone; maintaining a temperature of 25-300° C., 50° C. to 300° C., 100° C. to 300° C., 150° C. to 300° C., 200° C. to 300° C., 250° C. to 300° C., 280° C. to 300° C., or any temperature or temperature range falling with the range of 25° C. to 300° C. in the plasma discharge zone; and/or achieving an electron density of 10⁹ to 10¹³ cm⁻³, 10¹⁰ to 10¹³ cm⁻³, 10¹¹ to 10¹³ cm⁻³, 10¹² to 10¹³ cm⁻³, 10¹¹ cm⁻³, or any electron density or electron density range falling within the range of 10⁹ to 10¹³ cm⁻³ in the plasma discharge zone.

In exemplary embodiments, the synthesizing hydrogen cyanide from the methyl radicals and the nitrogen radicals in the plasma discharge zone of the DBD reactor requires an energy of consumption of at least 75 kJ/mmol, at least 70 kJ/mmol, at least 60 kJ/mmol, at least 50 kJ/mmol, at least 45 kJ/mmol, at least 40 kJ/mmol, at least 35 kJ/mmol, at least 30 kJ/mmol or any energy of consumption or range of energy consumption falling within 30 kJ/mmol to 75 kJ/mmol of hydrogen cyanide.

In exemplary embodiments, the method has a lower bound of 0.1 kg of CO₂ equivalent emissions, 0.2 kg of CO₂ equivalent emissions, 0.3 kg of CO₂ equivalent emissions, 0.5 kg of CO₂ equivalent emissions, 1.0 kg of CO₂ equivalent emissions, or 1.3 kg of CO₂ equivalent emissions per kilogram of hydrogen cyanide synthesized. In exemplary embodiments, the method has any CO₂ equivalent emission or range of CO₂ equivalent emission falling within the range of 0.1 kg to 1.3 kg of CO₂ equivalent emissions per kilogram of hydrogen cyanide synthesized.

In exemplary embodiments, the method is performed on a laboratory scale (e.g., the method is performed with a total flow rate of up to 0.2 L/min).

In exemplary embodiments, the method is performed on an industrial scale (e.g., the method is performed with a process flow rate of at least 1 L/min (see U.S. Pat. No. 7,070,743 B2, all the contents of which are incorporated herein by reference in their entirety). Those of ordinary skill in the art are readily capable of modifying the methods and systems disclosed herein to where they would be applicable on an industrial scale (see Z. Jianli, Z. Juncheng, S. Ji, G. Hongchen, W. Xiangsheng, G. Weimin, “Scale-up synthesis of hydrogen peroxide from H₂/O₂ with multiple parallel DBD tubes”, Plasma Science and Technology 11 (2009)).

Another aspect of the present disclosure is a system for synthesizing hydrogen cyanide including one or more of: a first storage compartment configured to store nitrogen gas; a second storage compartment configured to store a gas mixture containing methane gas and nitrogen gas; a mixer configured to receive and mix together a stream of nitrogen gas from the first storage compartment and a stream of the gas mixture from the second storage compartment; and a plasma reactor in communication with the mixer.

In exemplary embodiments, the plasma reactor in the system possesses a plasma discharge zone between a high voltage electrode and a grounding electrode separated by a dielectric barrier. High voltage and grounding electrodes are metals connected to a power supply and the ground, respectively. Examples of metals that can be used in these electrodes include, but are not limited to, brass and stainless steel. Any metals that are capable of producing high voltages and known by those of ordinary skill can be used in the electrodes. High voltage operations can include using alternating currents of more than 1 kV. The dielectric barrier can be made from quartz, borosilicate glass and/or ceramics.

In exemplary embodiments, the system includes an oscilloscope, a high voltage probe (e.g., Tektronix P6015A) in communication with a high voltage electrode, an oscilloscope, and a high voltage power supply (e.g., Amp-Line plasma power supply systems).

In exemplary embodiments, the system includes a temperature reader, an optical fiber (e.g., FOT-L-BA-C1-F1-M2-R1-ST, FISO) and a temperature signal recorder (e.g., FISOCommander 2) in communication with the plasma reactor.

In exemplary embodiments, the system includes an export line in communication with the plasma reactor, the export line being configured to transport gaseous products to a vent or a gas chromatographer. The export line can be made of stainless steel or fluoropolymer tubing. In exemplary embodiments, the export line is coated with tape heaters to avoid condensation of the gaseous products. In exemplary embodiments, the export line includes a pressure gauge.

### EXAMPLES

The present disclosure will be described in more detail with reference to the following Examples, which shows exemplary embodiments in accordance with the present disclosure. The present disclosure is not limited to these exemplary embodiments.

### Example 1

The goal of this experimental study was to determine whether electrification could enable alternative direct synthesis pathways for hydrogen cyanide that consumed less energy and produced lower CO₂ emissions when compared to conventional industrial processes.

### Selective Plasma-Assisted HCN Synthesis

A coaxial DBD reactor was used in this experimental study. The coaxial DBD reactor possessed a brass hollow tube high voltage (HV) electrode secured on the outer surface of a quartz tubular reactor and a stainless-steel rod ground electrode inside the quartz tube. The coaxial DBD reactor also possessed an AC power supply. The voltage (V) and current (I) waveforms of the AC power supply and the temperature at the reactor outlet was monitored during the experimental study. CH₄ gas in excess N₂ gas without an inert gas, such as He or Ar, was flowed into the DBD reactor.

The conversion of the N₂/CH₄ gas mixture requires the dissociation of a C—H bond in methane and dissociation of the N≡N bonds of the nitrogen gas. In plasmas, bond dissociation occurs through collisions of neutral molecules and electrons of kinetic energies higher than a threshold. The energies required to disassociate the C—H and N≡N bonds by direct electron impact (e-impact) are as follows:

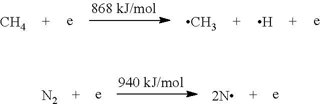

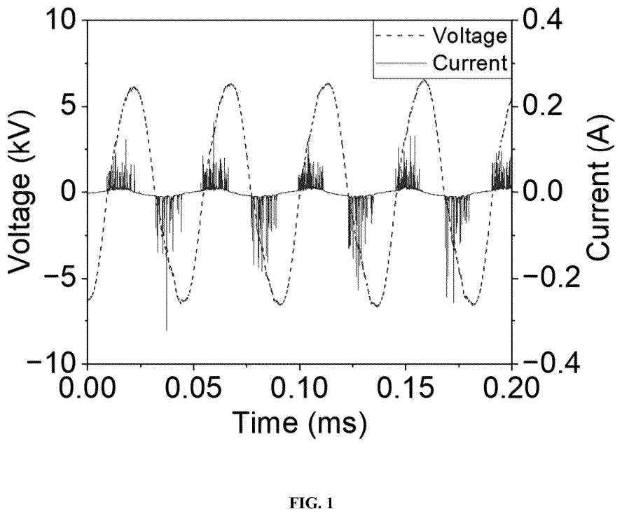

For a feed CH₄ fraction, C_{CH}_{₄}_{,0}, in the range of 0.1-10%, and a maximum total flow rate of 200 sccm, the required instantaneous power for full methane conversion ranges from 0.2 to 18.6 W. A dissipating power of about 30 W (estimated average of the system based on V-I waveforms (FIG. 1) should be adequate to achieve full conversion.

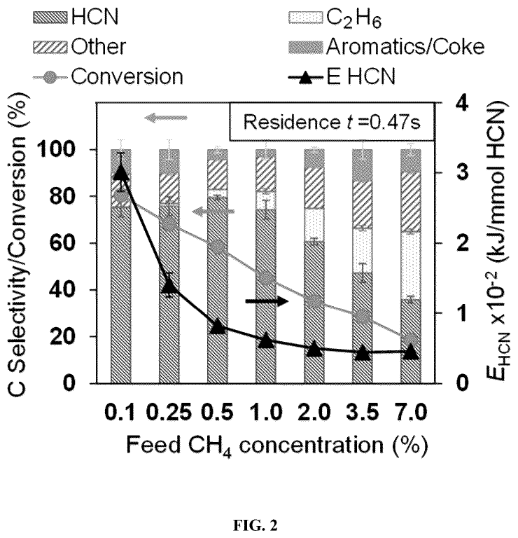

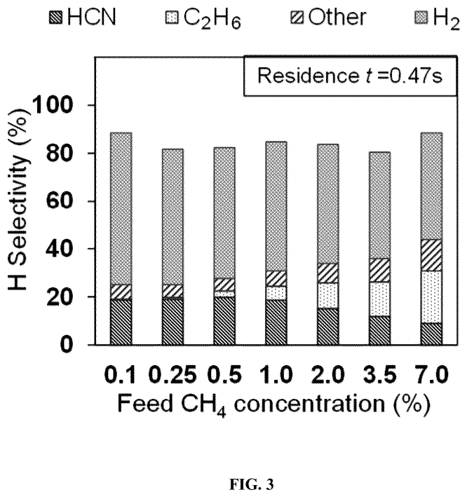

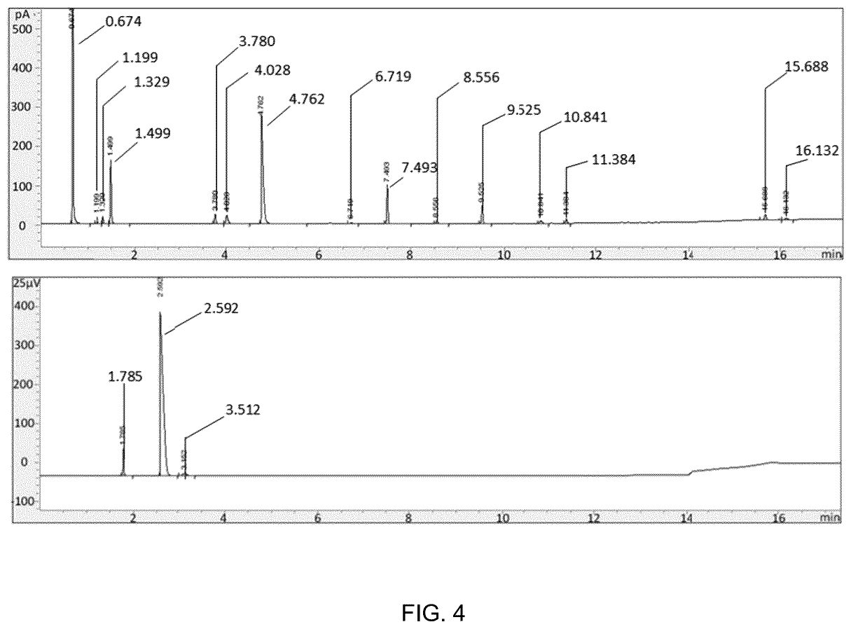

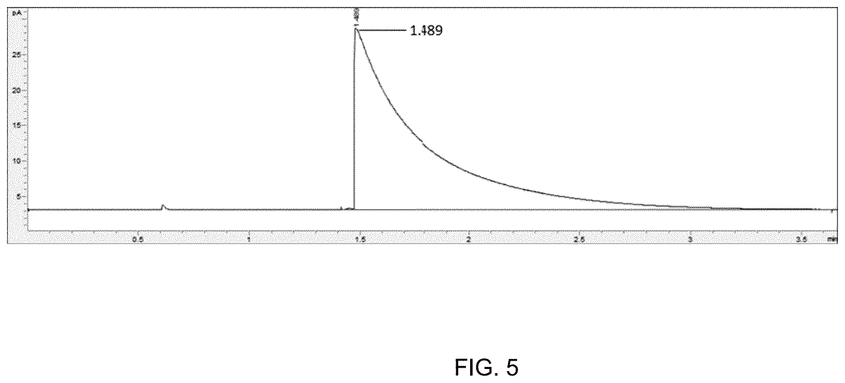

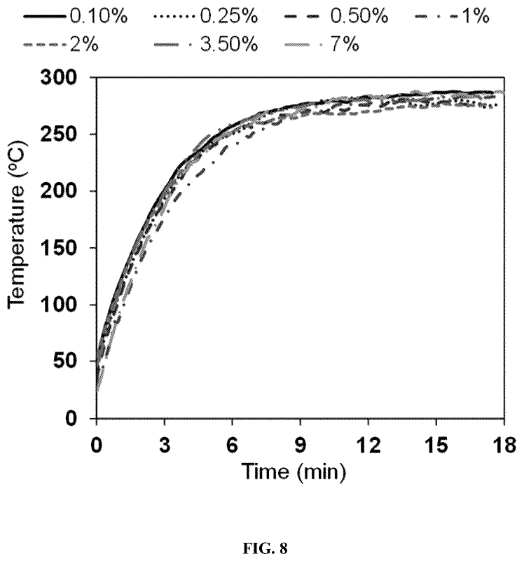

FIG. 2 and FIG. 3 show the CH₄ conversion, product selectivity, and HCN energy consumption, E_{HCN}, vs. the CH₄ feed fraction. Interestingly, the most prominent carbon-based products are HCN and ethane (C₂H₆), with HCN dominating for low methane concentrations. C₂H₆ selectivity increased with methane feed fraction due to CH₄ radical (·CHₓ) oligomerization. Aromatics and coke formation was observed for all experimental conditions, with an average selectivity of 10%. H₂ is another major product with similar selectivity trends to HCN, i.e., highest selectivity at low methane feed fractions. NH₃ formation was not observed (FIG. 4 and FIG. 5). The highest HCN yield, Y_{HCN}, was 72% with 80% selectivity and the lowest E_{HCN} was 44 kJ/mmol HCN produced. The temperature was 282° C. (FIG. 8), lower than commercial processes by 700° C. This suggests that a N₂/CH₄ DBD plasma can be a green alternative for selective, direct HCN synthesis from methane and nitrogen, especially of dilute methane streams, bypassing the need for ammonia.

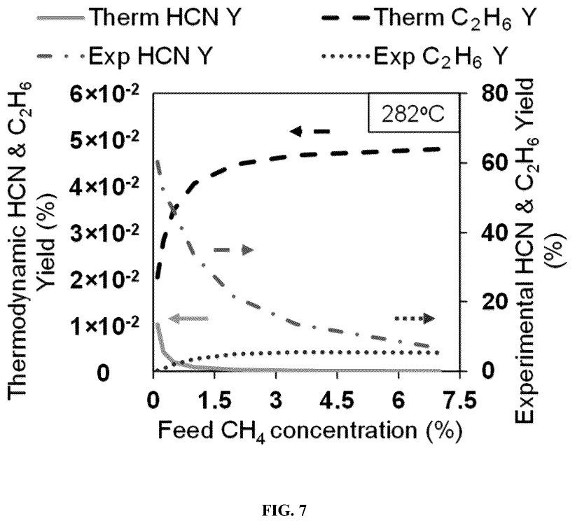

Thermodynamic equilibrium limitations can be the largest barrier to obtaining high yields and conversions in gas phase reactions. FIG. 7 displays HCN and ethane yields vs. CH₄ feed fraction at the operating conditions, 2820° C. and 1 atm, as predicted by a thermodynamic equilibrium model (see Python Multiscale Thermochemistry Toolbox (pMuTT)). Experimental yields by the N₂/CH₄ DBD plasma are also included for comparison. In conventionally heated systems at these conditions, ethane is the primary product with minimal HCN yields. Remarkably, non-thermal plasma activation of nitrogen and methane led to up to 60% HCN yield. Due to the effective activation of N₂ by high energy electrons, HCN was selectively produced over C₂H₆ for methane fractions up to 7%, while thermodynamics dictate that in a conventional reactor of the same gas temperature, the maximum CH₄ feed fraction for selective HCN production was 1%.

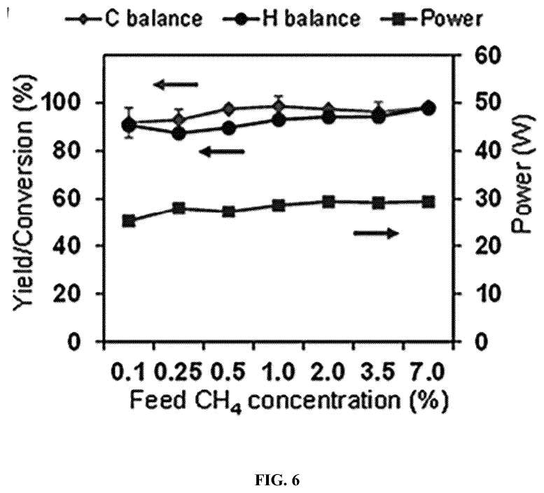

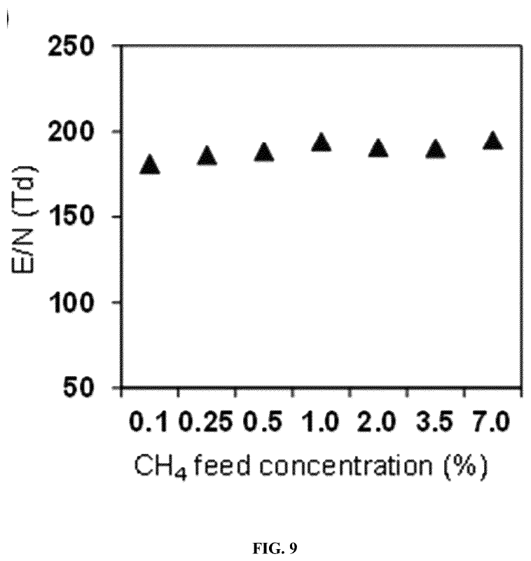

The CH₄ concentration in the gas feed affected the plasma properties and reacting species. In the operating range of 282° C. and 1 atm, methane and, thus, ·CHₓ were the limiting reagents. The primary characteristic of the plasma discharge is the electron energy distribution function (EEDF), which controls the rate of electron impact reactions responsible for the ensuing chemical interactions. EEDF depends on the gas composition, reduced electric field (E/N), discharge power (P), AC field frequency, and gas temperature (T_{g}). P and T_{g} were relatively constant at 28.1 W and 282° C., respectively (FIG. 6 and FIG. 8). Similarly, E/N remained constant across experimental conditions (FIG. 9). With the AC field frequency also fixed, the only variable notably affecting EEDF was methane concentration. Hence, the impact of methane concentration on HCN selectivity is the combined effect of the kinetic rates of electron impact, radical-radical, molecule-radical, and molecular reactions.

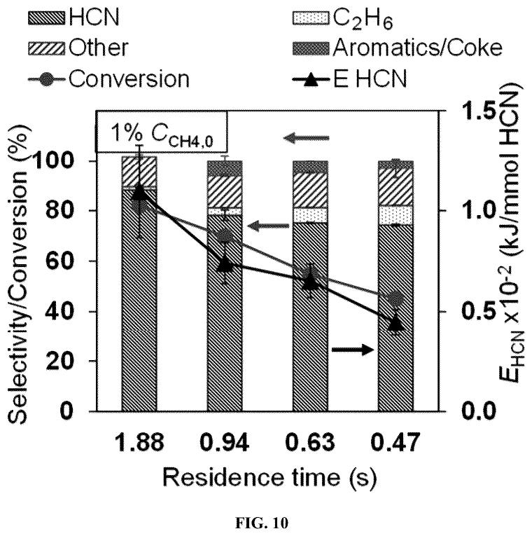

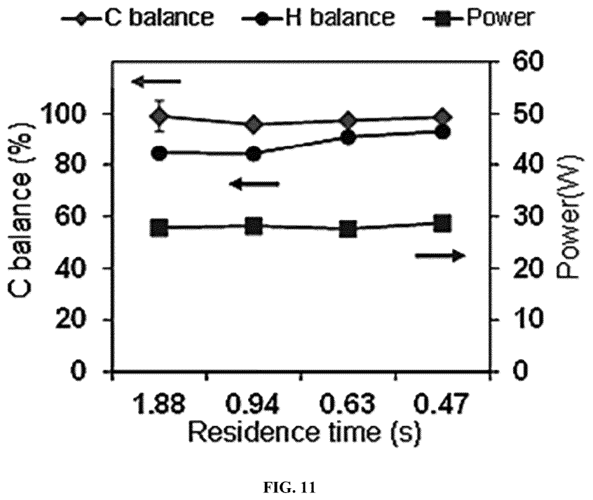

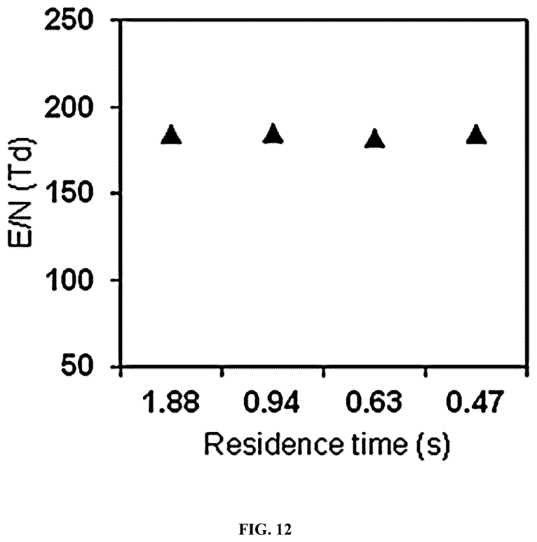

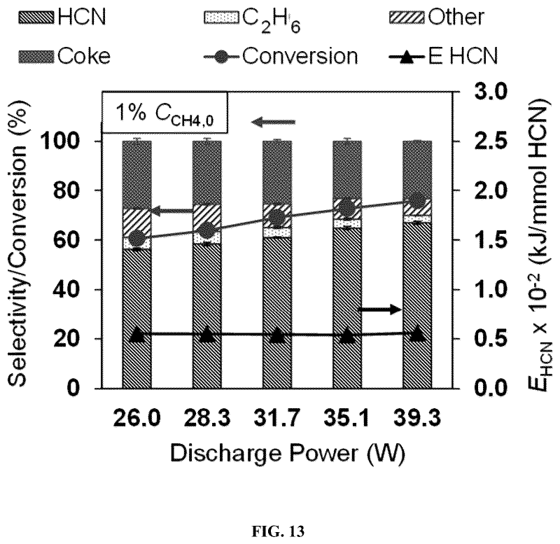

The effect of plasma residence time on HCN selectivity, SHCN, and energy consumption is depicted in FIG. 10. Conversion, selectivity, and E_{HCN} are proportional to residence time. Given P, T_{g} and E/N were constant with varying residence time (FIG. 8, FIG. 11 and FIG. 12), HCN selectivity is primarily controlled by kinetics. The dependence of HCN selectivity on residence time suggests that HCN decomposition reactions are much slower than formation reactions. Examining the individual effect of discharge power, it was found that P is linearly correlated with methane conversion and HCN selectivity and has no substantial effect on product distribution (FIG. 13).

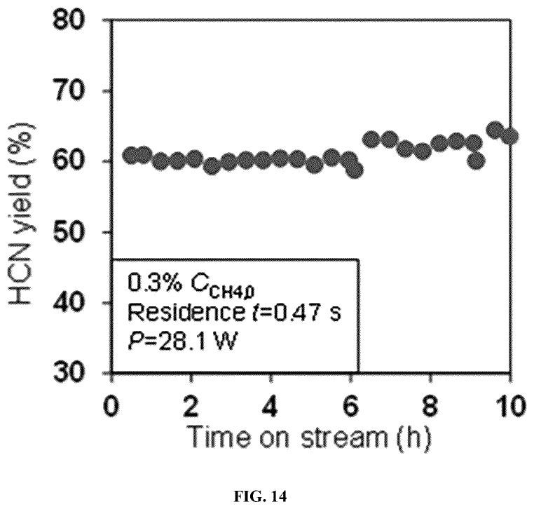

The stability of this process was determined through 10-hour continuous operation experiments for the investigated concentrations. FIG. 14 depicts HCN yield with time on stream for 0.3% feed CH₄ concentration and 0.47 s residence time. HCN yield was not adversely affected by time on stream, establishing that plasma-assisted conversion of CH₄ and N₂ is a stable process that can be operated continuously. One possibility for the slight increase in HCN yield over time could be the partial rehydrogenation of coke depositions on the reactor walls and inner electrodes and reaction with excited N₂ species.

Chemistry Insights Plasma-assisted CH₄ conversion chemistry has received considerable attention, with emphasis on excited species. A OD plasma kinetic model can consider many vibrationally and rotationally excited and metastable species, radicals, and charged and neutral molecules. A plasma kinetics model for the exemplary HCN synthesis method was developed (see Microkinetic model setup), wherein 35 neutral radicals (critical intermediates) in state-of-the-art CH₄/N₂ pyrolysis mechanisms were considered. Steady state E/N, nₑ, and T_{g} conditions were assumed to evaluate the average rates of 62 electron impact reactions and integrate those into user-friendly compiled software CHEMKIN III to model the kinetics of 251 chemical reactions (see Microkinetic model setup). By doing this, electron impact reactions were reduced by up to 80% compared to DBD plasma modeling.

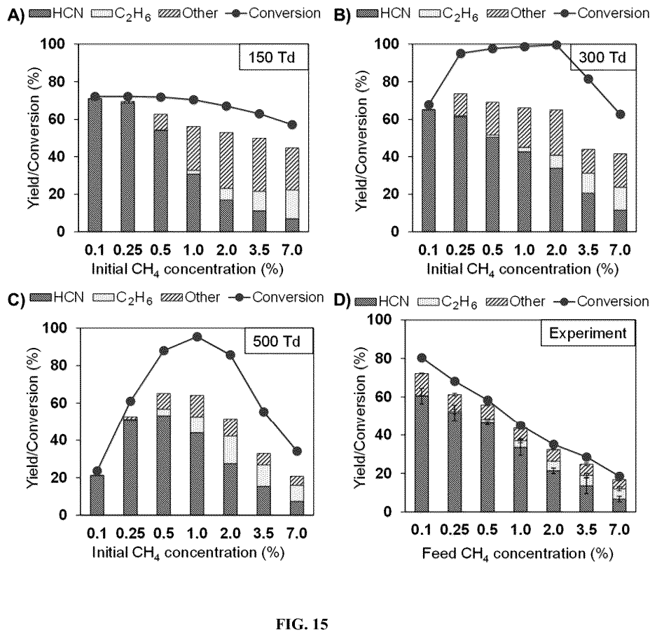

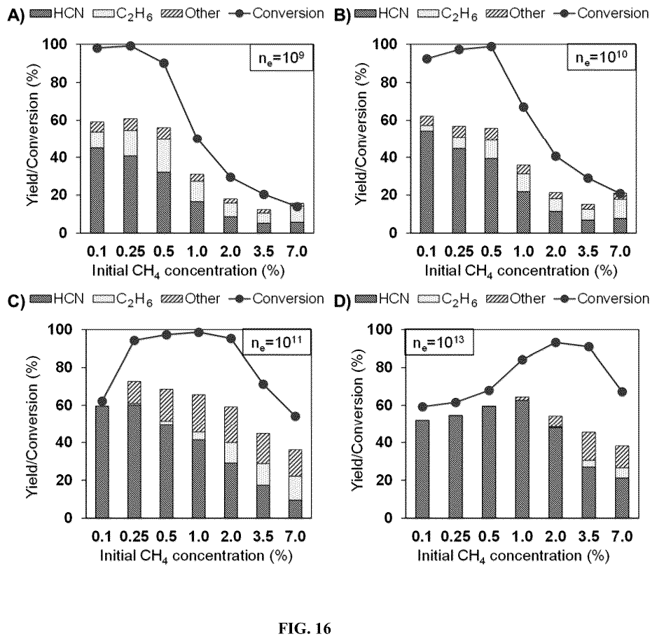

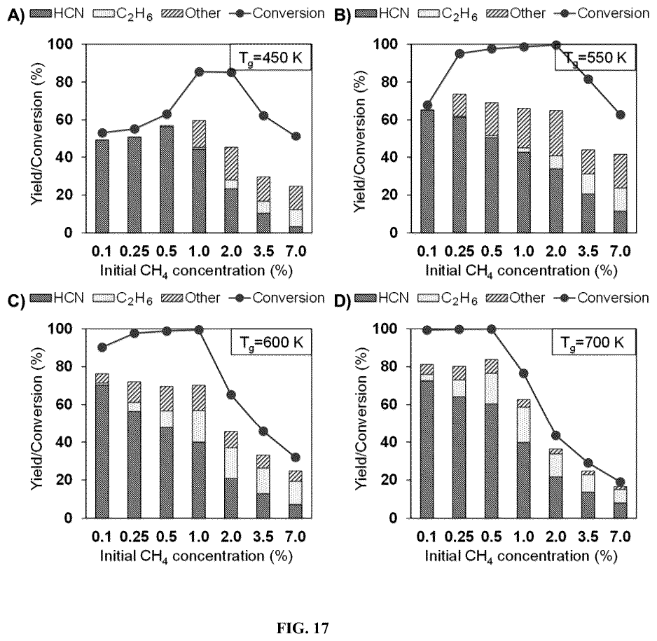

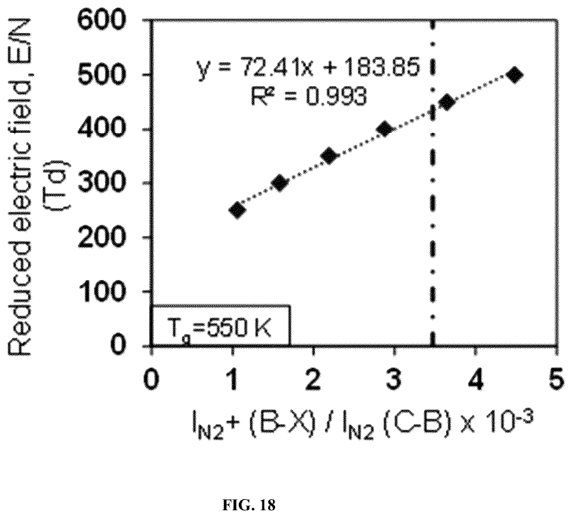

The first goal was to assess the model's capability to replicate experimental trends and ascertain suitable E/N, T_{g}, and electron density (nₑ) ranges. Parametric studies by varying E/N, T_{g} and nₑ (FIG. 15, FIG. 16 and FIG. 17) showed that E/N=300 Td, T_{g}=550 K, nₑ=10¹¹ cm³ best capture the experimental data. The reduced electric field, about 300 Td, was in the range of the average experimental estimates of 189 and 435 Td (FIG. 9 and FIG. 18). The other values correspond to experimental conditions estimated by thermometry, relative irradiance, and other methods.

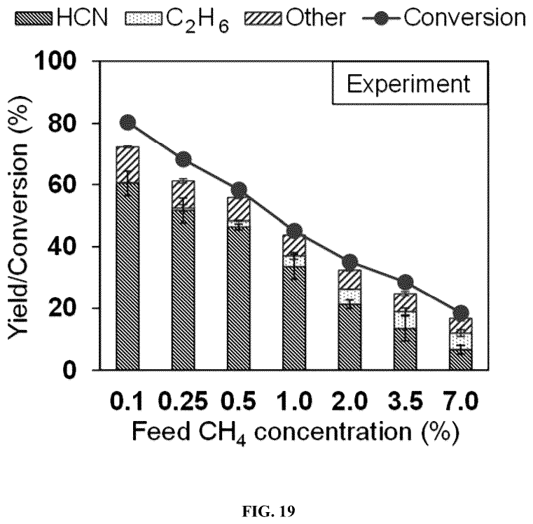

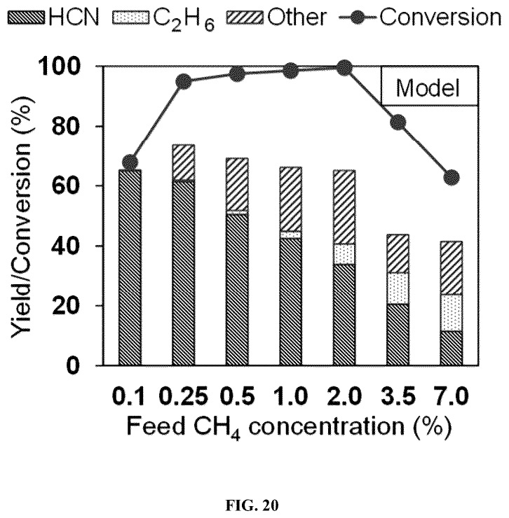

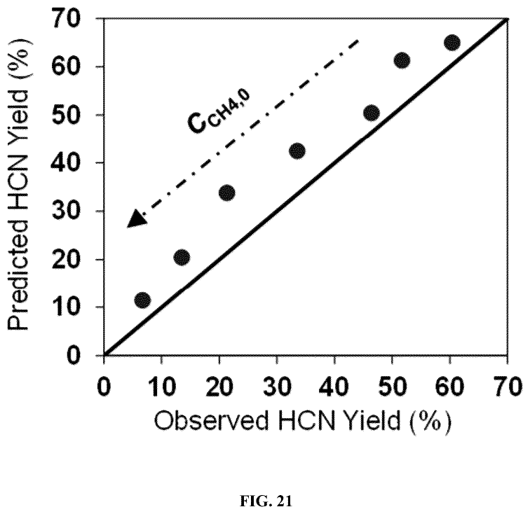

FIG. 19 and FIG. 20 display the experimental and predicted product yield and CH₄ conversion vs. the CH₄ feed fraction. The model captures the experimental yields of HCN and C₂H₆ reasonably, within 30% and 50% average deviation, respectively. A parity plot of HCN yield is shown in FIG. 21. The model consistently slightly overpredicts HCN yield over the investigated concentration range, inferring that the validity range of the kinetic model is in the range 0.1-100% methane feed fraction. Literature reports similar average deviations of 25-37% in product selectivities for a CH₄ DBD reactor. This demonstrates that the model successfully predicts experimental major products in DBD plasmas. The conversion and other small carbon-product yield trends are not fully captured by the model, which is reasonable considering the complex reaction network.

The yields in FIG. 20 correspond to a computed residence time of about 1.3 ms. A residence time of 0.47 s was estimated based on the reactor volume and gas flow rate. This comparison of experimental and computational residence times indicates that the actual plasma exposure is 100× shorter than the simple estimate. This suggests the dispersed plasma streamers occupy only a small fraction of the reactor volume. The ratio of the plasma streamers to the empty reactor is about 0.3%. The corresponding number of microdischarges per discharge cycle is 67.

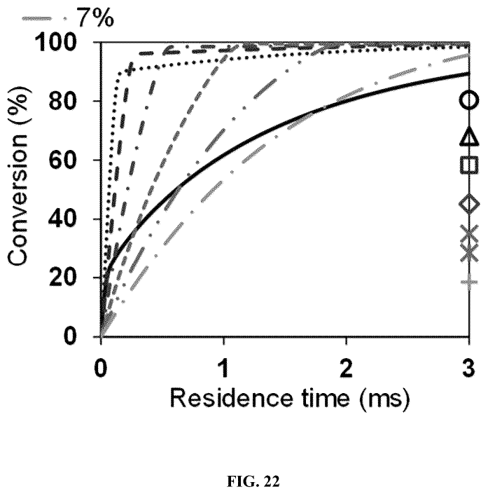

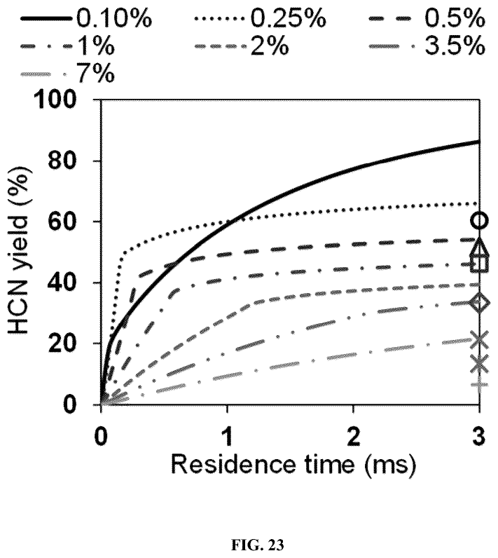

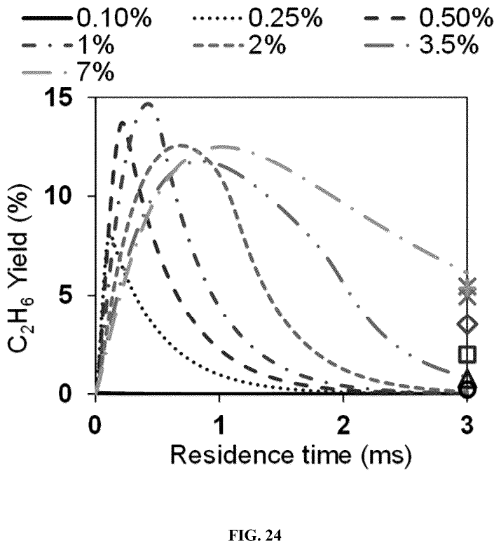

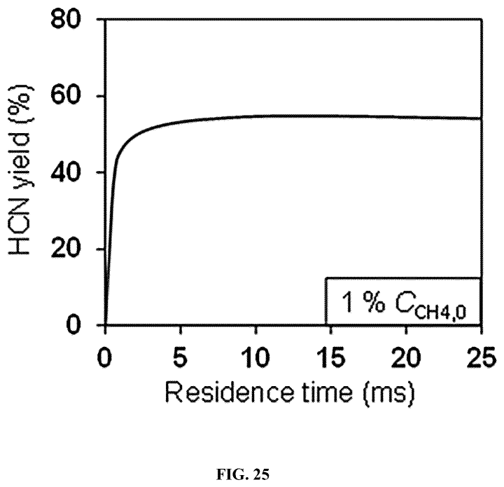

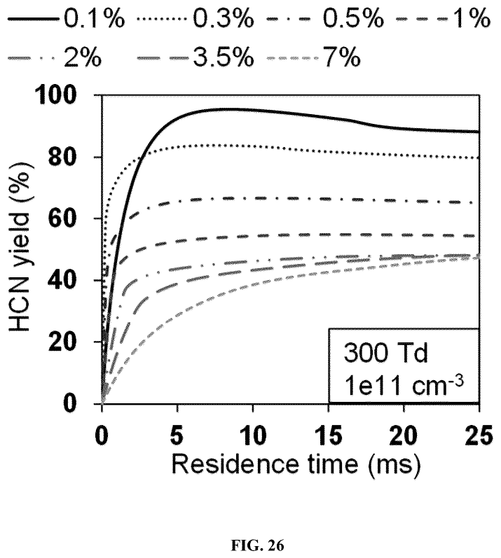

Having predicted the effect of CH₄ concentration on HCN yield, the effect of residence time was next examined. The evolution of CH₄ conversion, HCN, and C₂H₆ yield with residence time up to 3 ms is shown in FIG. 22, FIG. 23 and FIG. 24. The trends changed dynamically with methane feed fraction in the first 3 ms. Ethane yield is maximized in the 1st ms and then rapidly declines, indicating prevalent contributions of consumption reactions. The highest HCN yield for longer residence times was achieved by the lowest feed CH₄ fraction. The microkinetic model predicts an increase of HCN yield with increasing residence time before seemingly settling around a lower value (FIG. 25). This steady state of HCN yield is also featured over the entire methane feed fraction range investigated (FIG. 26), suggesting an upper limit for each C_{CH}_{₄}_{,0} condition. Notably, for C_{CH}_{₄}_{,0}≥2%, the upper limit for HCN yield conglomerated around 48% under these conditions. The increasing conversion with increasing residence time observed experimentally was also corroborated by the model at intermediate conversions (FIG. 22).

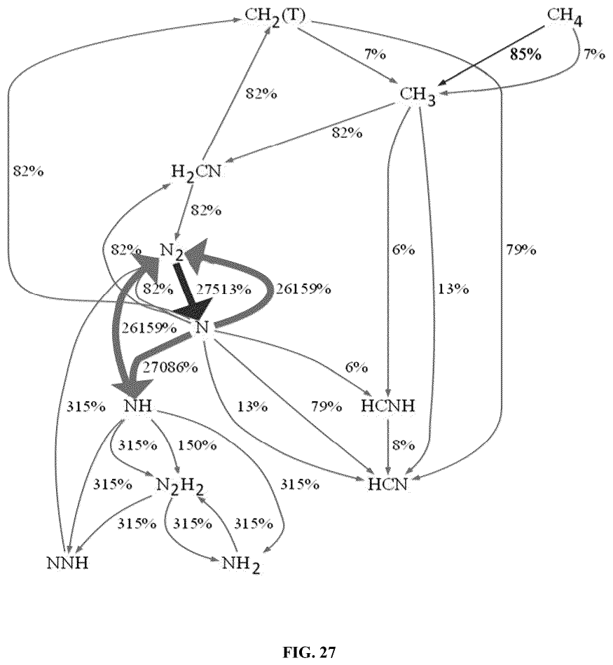

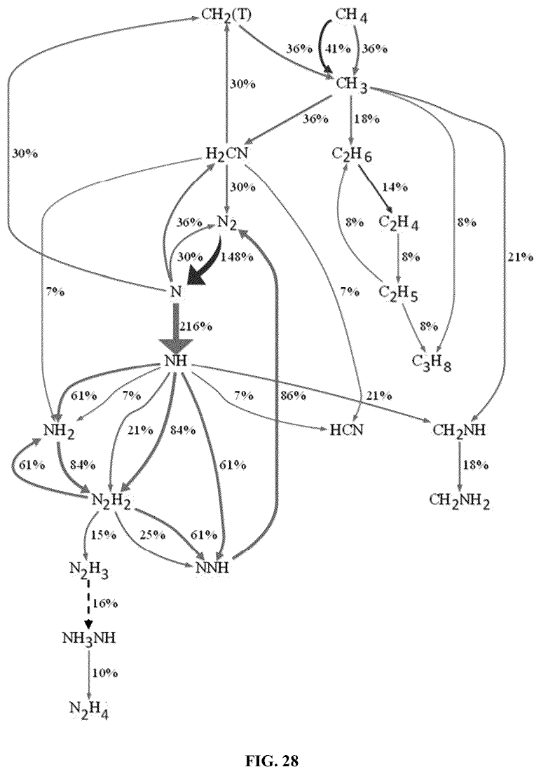

Upon establishing the model's reasonableness, the reaction pathways were next elucidated. Reaction path analysis (RPA) is shown in FIGS. 27 and 28. For lower methane concentrations, important electron impact dissociation reactions are those of N₂ to ·N and of CH₄ to methyl radical (·CH₃). The remaining notable reactions correspond to thermal reactions, while HCN is the prominent C-derived product (FIG. 27). For higher methane concentrations, the thermal contribution to methane decomposition via the disproportionation reaction CH₄+CH₂→2CH₃ increases (FIG. 28), and ethane is another major product. The methyl radical is a common intermediate to HCN and C₂H₆, with C₂H₆ production increasing with increasing C_{CH}_{₄}_{,0} due to the bimolecular nature of this reaction.

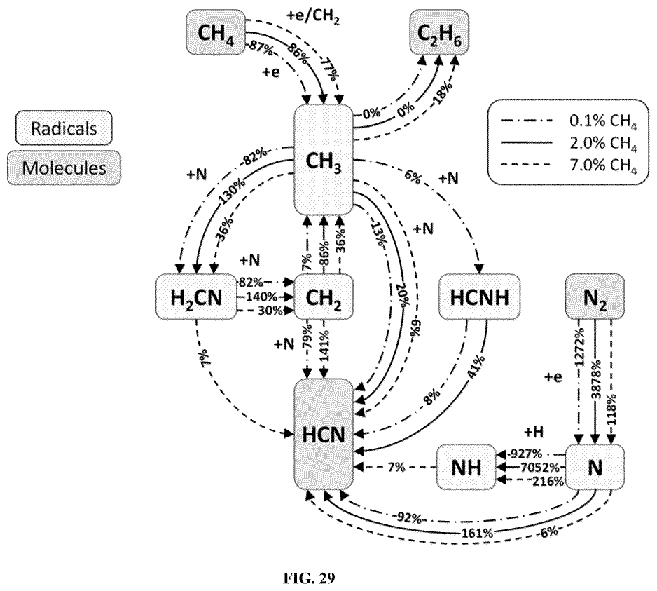

Reaction pathways contributing to HCN generation for various methane feed fractions are displayed in FIG. 29. For low methane feed fractions (0.1%), HCN production began with the e-impact formations of ·CH₃ from CH₄ and ·N from N₂. The methyl radical subsequently reacted with ·N towards methylene amidogen radical (·H₂CN), which then recombined with ·N to form methylene radical (·CH₂) and N₂. ·CH₂ further reacted with ·N to produce HCN, constituting the primary pathway for HCN synthesis. Reactions of ·CH₃ with ·N and imino methyl radical (HCNH·) decomposition also contributed to HCN formation. For higher methane feed fractions (2 and 7%), ·CH₃ formed both via electron impact dissociation and thermal decomposition of CH₄ (via collisions with ·CH₂). ·H₂CN mainly contributed to HCN production via its reaction with ·NH, which was formed from ·N and ·H. The reaction of ·CH₃ with ·N became a primary pathway toward HCN generation, while the reaction of ·CH₂ with ·N was reduced to a lesser flux.

Ethane production at low methane concentrations was limited by the recombination of two ·C₂H₅ (2C₂H₅→C₂H₆+C₂H₄). For higher concentrations, the rate of formation of C₂H₆ substantially increased through the third-body recombination reaction of methyl radical (2CH₃+M→C₂H₆+M). Ethane's primary consumption pathways included decomposition reactions to C₂Hₓ (x=2-5) (FIG. 28). FIG. 29 also demonstrates how increasing ·CH₃ dimerization reduces the total flux to HCN.

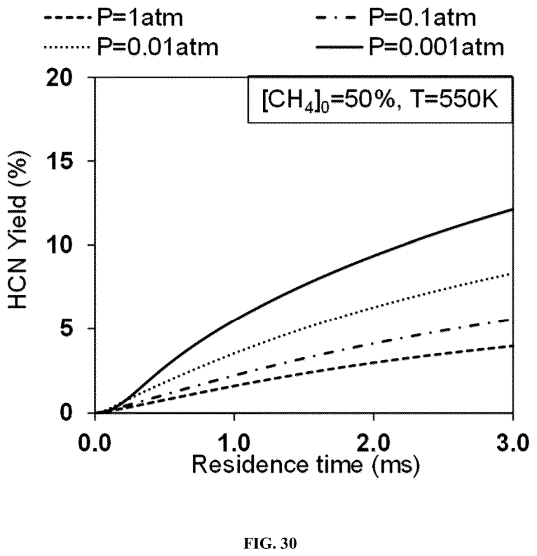

To increase HCN throughput, i.e., increase HCN selectivity at higher methane feed concentrations, the effect of operating conditions on product distribution was investigated. HCN yield can be improved by altering plasma operating conditions (increasing reduced electric field and electron density), increasing reactor temperature (FIG. 17), or decreasing operating pressure (FIG. 30). FIG. 30 demonstrates that for 50% methane feed concentration, HCN yield can be increased 3× by operating at 0.001 atm instead of 1 atm.

Comparison with Existing Processes

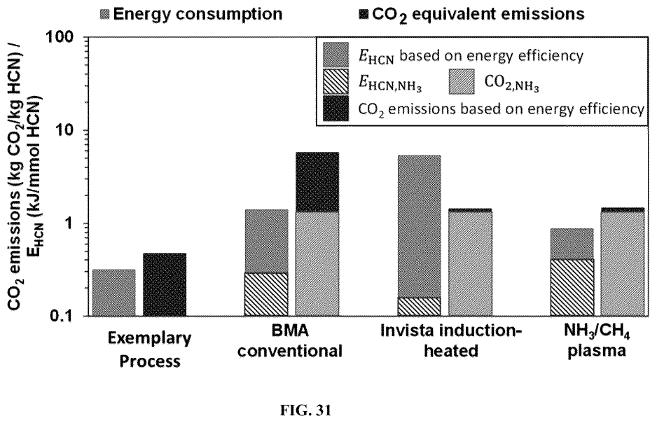

Direct comparison with established industrial (BMA, Invista) processes and plasma processes with 10-40× richer CH₄ feedstock, indicated that the energy demand per mmol of HCN in the exemplary process was 10-40× higher than other reported values (FIG. 31) because of the low plasma efficiency and dilute CH₄ streams. Optimization of plasma reactors and power generators is still in its early stages, due to the recent emergence of non-thermal plasmas for chemical transformations. Separation and purification energy costs are not considered in FIG. 31 for any process. A comparison between HCN recovery in conventional processes and the exemplary N₂/CH₄ plasma HCN synthesis process indicated a reduction in separation costs by at least 97% for the exemplary N₂/CH₄ plasma HCN synthesis.

The energy efficiency of plasma and industrial processes was an integral part of this comparison. Reported plasma processes demonstrate efficiencies below 10%, while the BMA process has been rigorously optimized over 50 years to reduce its energy consumption by 70%. The Invista process, a more recent induction heated process, also has a high efficiency of 89%. The energy efficiency of the exemplary N₂/CH₄ plasma HCN synthesis process, associated with the chemical reaction, gas heating and plasma dissociation, was estimated at about 4%. Heat losses in microchemical systems were considerable and thus energy efficiency improved dramatically with scale up and optimization. Energy losses related to targeted species excitation and conservation in the plasma region were also substantial and can be improved by optimizing the reactor geometry. Considering the power efficiently dissipated in each reactor, the two plasma processes exhibited the lowest thermodynamic energy requirements. Hence, a more efficient generator and reactor design could bridge the energy gap with industrial processes.

Other works in similar DBD systems demonstrated that energy efficiency of plasma processes increased by increasing reactor throughput and using multiple reactors in parallel. Industrial ozone production also utilized multiple parallel DBD reactors powered by the same generator. Scaling up and scaling out the current N₂/CH₄ plasma system to accommodate industrial slip gas volumes could further improve energy efficiency.

With the decarbonization of the chemical industry, CO₂ equivalent emissions are a very important metric for new processes. Electrified reactors can be powered by renewable electricity due to their fast initiation/termination times and reaction rates, while conventional reactors are limited to continuous energy sources. Assuming a wind onshore energy source for the Invista and plasma processes, and the US electricity grid for the BMA, CO₂ equivalent emissions of the exemplary N₂/CH₄ plasma HCN synthesis process used in this example, based on input power, are among those of commercial processes (FIG. 31).

CO₂ equivalent emissions (CO₂ eq. emissions) for all processes are evaluated according to the following equation:

$${CO}_{2} eq . emissions ( \frac{kg {CO}_{2}}{kg HCN} ) = \frac{{E}_{HCN , process}}{{M}_{HCN}} \times 1000 \times {F}_{{CO}_{2} , s} + {CO}_{2 , {NH}_{3}}$$

Here E_{HCN,process} is the energy consumption of the process(2, 14, 30),

$${M}_{HCN} = 27.03 \frac{g}{mol}$$

is the molecular weight of HCN, F_{CO}_{₂}_{,s} is the CO₂ equivalent emission factor of the energy source-equal to

$$0.86 \frac{lbs {CO}_{2}}{kWh} = 1.1 \times 1 {0}^{- 4} \frac{kg {CO}_{2}}{kJ}$$

for the US electricity grid (BMA process) and to

$$11 \frac{g {CO}_{2}}{kWh} = 3.1 \times 1 {0}^{- 6} \frac{kg {CO}_{2}}{kJ}$$

for a wind onshore source (plasma and Invista processes) and CO_{2,NH}_{₃} is the contribution of NH₃ feedstock to CO₂ equivalent emissions. Compared to the NH₃/CH₄ prior plasma work (30% CH₄ conversion and about 24% HCN yield, using 5.2 kJ/mmol HCN produced), the direct, exemplary N₂/CH₄ plasma HCN synthesis process of this example reached more than double HCN yield.

All reported processes use NH₃, which contribute to their CO₂ eq. emissions by about 1.5 kg CO₂/kg HCN (light grey mesh in FIG. 31). Irrespective of reactor efficiencies, these processes are going to be limited by CO₂ eq. emissions from NH₃. The exemplary N₂/CH₄ plasma process used in this example, limited only by reactor and generator inefficiencies, could reach 0.2 kg CO₂/kg HCN, a much lower threshold than 1.5. Considering that the only impediment to reaching that limit is optimization, N₂/CH₄ plasma paves the way to fully electrified HCN synthesis with minimal CO₂ equivalent emissions.

### CONCLUSIONS

HCN storage and handling are challenging due to its high volatility, toxicity, and instability in the presence of impurities. Developing distributed and small-scale HCN synthesis processing could facilitate on-demand production while minimizing extensive storage requirements. Current HCN production processes are limited by the use of ammonia which requires multiple carbon intensive synthesis steps and is incompatible with small-scale processing. Non-thermal plasma has been proposed for decentralized chemical processing powered by renewable electricity due to its intermittent process capability.

In this example, an electrified, catalyst-free, N₂/CH₄ plasma process capable of selective HCN synthesis at much lower temperatures than current industrial processes have been developed. A maximum HCN yield of 72% was achieved with ethane as a secondary product, notably outperforming conventionally heated systems at the same conditions. A simplified automated plasma model, i.e., assuming constant plasma conductivity and neutral radicals as the primary reactive species, has successfully replicated the yield trends of the prominent products. Methyl radical is a crucial intermediate from CH₄ related to HCN generation and, at higher methane concentrations, to C₂H₆ synthesis. Thermal contributions to methane decomposition increased at higher methane concentrations. Comparing this exemplary process to current industrial ones, plasma systems are shown to have the lowest thermodynamic energy requirements. The exemplary process has also demonstrated a tenfold reduction in CO₂ equivalent emissions compared to using NH₃.

In summary, this example establishes N₂/CH₄ plasma as a promising route toward selective HCN synthesis with minimal CO₂ equivalent emissions. The process can be suited to convert methane from leaks and slip from combustion processes that contain a small fraction of CH₄ and a large fraction of N₂ from the oxidant (air).

### Methods Used in Example 1

### Reactor Setup and Analysis

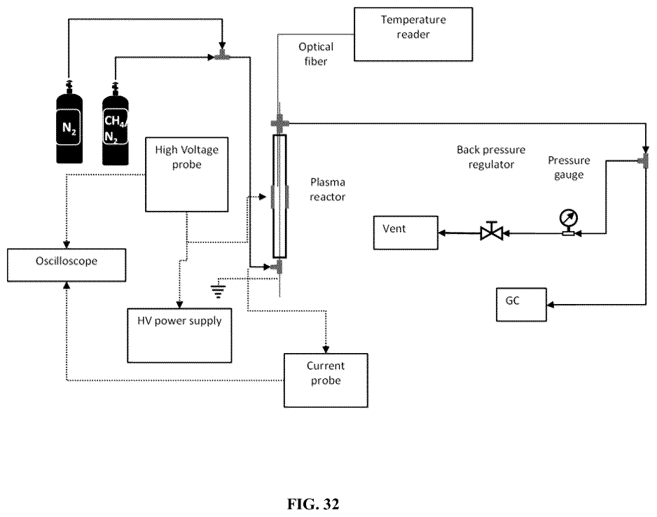

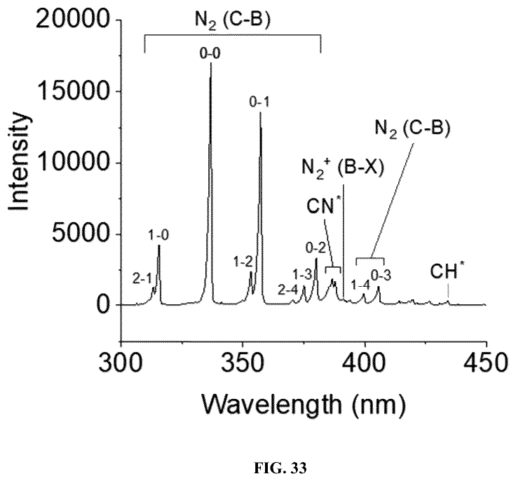

An overview of the experimental setup is displayed in FIG. 32. The dielectric barrier discharge (DBD) reactor used in this example consisted of a brass hollow tube high voltage (HV) electrode (12.7 mm OD, 9.4 mm ID, McMaster-Carr) secured on the outer surface of the quartz tubular reactor (9 mm OD, 7 mm ID, 41 cm length, QSI Quartz Scientific) and a stainless-steel rod as the grounding electrode inside the quartz tube (3 mm diameter, 69 cm length McMaster-Carr). The reactor length, i.e., the HV electrode length, was 5 cm. The plasma was generated by an AC power supply (PVM500) at a frequency of 22 kHz connected to the HV and grounding electrodes. A voltage probe (Tektronix P6015A) was connected to the power supply, the HV electrode, and the ground. A current probe (Pearson 2100) was connected to the ground electrode. Both probes were also connected to an oscilloscope (Tektronix MD034). High purity N₂ (99.999%, Keen Compressed Gas) and a mixture of CH₄/N₂ (14% CH₄, Matheson gas) were premixed and flowed into the reactor at ambient temperature and pressure. Feed gas total flow rates ranged from 50 to 200 sccm and were regulated with mass flow controllers (Brooks GF40). The residence time was controlled by adjusting the gas total flow rate while the reactor volume remained constant at about 1.57 cm³. For the inert gas studies, pure argon (Ar) gas (99.999%, Keen Compressed Gas) or helium (He) gas (99.999%, Keen Compressed Gas) were premixed with CH₄ and N₂. Gas products were analyzed with inline gas chromatography (FIG. 4). The volume expansion is negligible for the experimental conditions (see Table 1). Select experiments of each set were performed in triplicate, with the average value shown in the figures. Selectivity and yields were evaluated on a CH₄ basis. Optical emission spectroscopy (OES) measurements were acquired during experiments by an optical fiber (400 μm slit width, Avantes) adjusted to a collimating lens and connected to an AvaSpec-ULS4096CL-EVO-UA-10 spectrometer (FIG. 33).

TABLE 1
Gas volumetric flow ratio (exit to initial) for feed CH₄
concentration experiments

| Methane feed fraction (%) | $\frac{Q}{{Q}_{0}}$ |
|---|---|
| 0.1 | 1.00 |
| 0.25 | 1.00 |
| 0.5 | 1.00 |
| 1.0 | 1.00 |
| 2.0 | 1.01 |
| 3.5 | 1.01 |
| 7.0 | 1.01 |

Gas volume ratio accounting for volume expansion (Equations S11 & S12) due to chemical reactions for variable feed CH₄ concentration experiments.

### Discharge Characteristics

FIG. 1 shows the electrical characteristics of the CH₄/N₂ plasma discharge. The current waveform reveals successive nanosecond current pulses occurring at each voltage half cycle, which indicates a streamer (filamentary) discharge mode. The short lifetime of the plasma streamers induces highly non-equilibrium conditions at atmospheric pressure, while the change in polarity disperses the filamentary discharges over the inter electrode volume.

### Thermometry

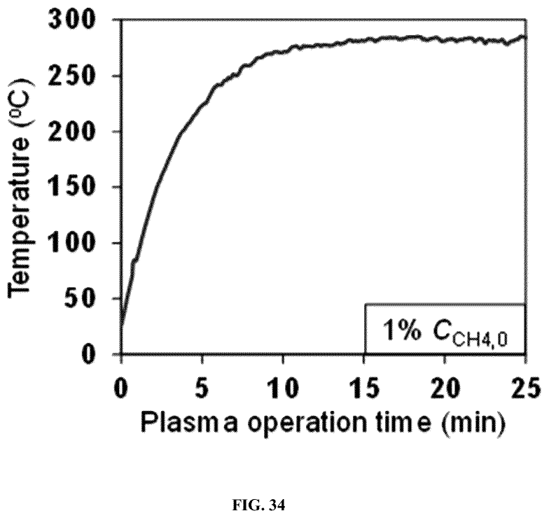

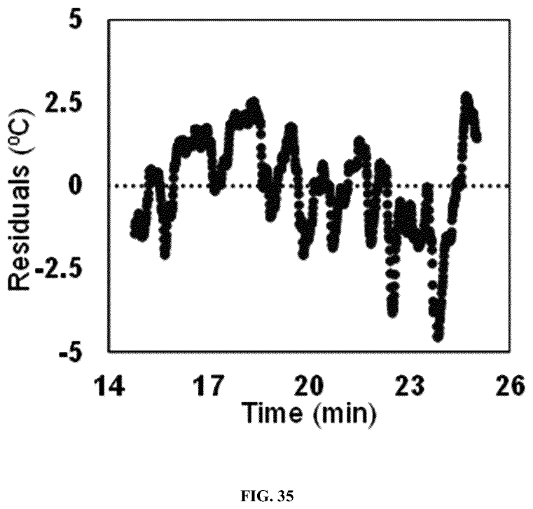

The gas temperature was measured by an optical fiber (FOT-L-BA-C1-F1-M2-R1-ST, FISO) suspended between the quartz tube and the inner electrode and 1 cm above the reactor (FIG. 32). The location of the fiber optic was the closest possible to the reactor without impacting the plasma field. The time required for the gas to reach the optical fiber from the reactor outlet was 0.09-0.38 s, depending on the flow rate. Hence, the average reaction temperature can be approximated by the gas temperature read by the fiber optic and the signal conditioner (UMI, FISO). The program used to record the temperature signal was FISOCommander 2 and the recording frequency was 1.67 s⁻¹. FIG. 34 depicts a typical gas temperature profile with continuous plasma operation time. The gas temperature plateaus for t≥10 min at an average of 282° C., corroborating the assumption of steady-state operation of the reactor. The random distribution of the residual gas temperature values around the average of 282° C. further validates the steady-state hypothesis (FIG. 35).

Python Multiscale Thermochemistry Toolbox (pMuTT)

The equilibrium concentration of methane, HCN and ethane at 282° C. and 1 atm was evaluated by the equilibrium model of pMuTT developed by Lym et al. (J. Lym, G. R. Wittreich, D. G. Vlachos, A Python Multiscale Thermochemistry Toolbox (pMuTT) for thermochemical and kinetic parameter estimation. Comput Phys Commun 247, 106864-106882 (2020)). The network of species considered included N₂, CH₄, HCN, C₂H₆, C₂H₄, C₂H₂, C₃H₈, C, H₂, NH₃, cyanogen (CN), diazene (N₂H₂), hydrazine (N₂H₄), acetonitrile (CH₃CN) and methylamine (CH₃NH₂). Thermodynamic data for these species were acquired from the RMG thermodynamic libraries.

### Microkinetic Model Setup

To elucidate the most prominent chemical reaction pathways in the CH₄/N₂ DBD plasma, a OD chemical kinetics model was developed. Until now, established OD plasma kinetic models used a Fortran module, such as ZDPlasKin, which calls a Boltzmann equation solver (BOLSIG+)(42) at each time integration step to evaluate the electron density, E/N, gas temperature, and reaction rates. While this approach allows transient E/N and nₑ calculations, it is computationally intensive.

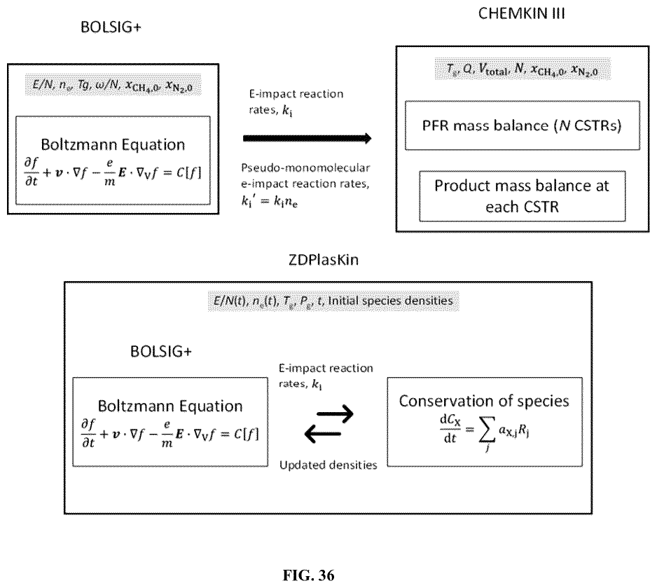

In this example, a user-friendly compiled chemical kinetic software CHEMKIN III was employed. Steady-state E/N, nₑ and T_{g} conditions were assumed and BOLSIG+ was used to evaluate the average rates of electron impact reactions and input them into CHEMKIN, eliminating the integrated BOLSIG+ loop from previous modules. A graphical representation of this approach is shown in FIG. 36.

Since E/N, nₑ and T_{g} were estimated experimentally but not with high accuracy, they were treated as variables examined over a range of values with the experimental measurements as focal points. E/N, nₑ and T_{g} were varied over a range of 150-500 Td, 10⁹-10¹³ cm⁻³ and 450-700 K, respectively, to ascertain the conditions most representative of the experimental results. Since the plasma/gas reactor conditions were considered homogeneous, the reaction rates of electron impact reactions were regarded as constant.

In DBDs with E/N≤500 Td, electron impact dissociation reactions are more prominent than ionization reactions; hence, ionization reactions were not included in the MKM. For further simplicity, only ground electronic and vibrational states of neutral radicals were considered, essentially assuming that excited CH₄ does not contribute to CH₄ dissociation and that in a high energy N₂ rich environment, direct N₂ dissociation produces N atoms sufficiently fast to propagate chemical interactions. However, to accurately estimate the rates of dissociation of electron impact reactions with BOLSIG+ version 12/2019, excitation, momentum transfer, attachment, and ionization reactions were accounted for. The cross-sectional data for CH₄ attachment, elastic momentum transfer, and vibrational excitation were obtained from the Morgan database and those for dissociative excitation and ionization of CₓH_{y} (x=1-3) species were evaluated based on the data and analytic forms reported by Janev et al. (R. K. Janev, D. Reiter, Collision processes of CHy and CHy+ hydrocarbons with plasma electrons and protons. Phys Plasmas 9, 4071-4081 (2002); and R. K. Janev, D. Reiter, Collision processes of C2,3Hy and C 2,3Hy+ hydrocarbons with electrons and protons. Phys Plasmas 11, 780-829 (2004)). The cross-sectional data for N₂ momentum transfer, attachment, vibrational, rotational and electronic excitation, and ionization were acquired from the Phelps database and those for N₂ and H₂ dissociation from the Itikawa database. The cross-sectional data for H₂ momentum transfer, vibrational, rotational, and electronic excitation and ionization were acquired from the Phelps database.

The electron impact reactions included in the MKM encompassed all neutral dissociation reactions of CHₓ radicals (x=1-4) and the most prominent ones of C₂H_{y} (y=0-6) and C₃H_{z} (z=5-8), based on their branching ratios, amounting to a total of 62 reactions. Interactions of neutrals and radicals with other excited species, such as electronically excited CH₄ and N₂, as well electron impact dissociation reactions of HCN and other nitriles, could be considered for a more accurate representation of the complete DBD plasma reaction network. A state-of-the-art pyrolysis reaction mechanism was primarily compiled from the “primaryNitrogenlibrary” RMG kinetic library and the nitrogen combustion network as delineated by Glarborg et al. (P. Glarborg, J. A. Miller, B. Ruscic, S. J. Klippenstein, Modeling nitrogen chemistry in combustion. Prog Energy Combust Sci 67, 31-68 (2018)). Select reactions from the “Nitrogen_Dean_and_Bozelli” RMG kinetic library and the GRI-Mech version 3.0 released on Jul. 30, 1999 were also included. Since the gas temperature was measured about 550 K, only reactions active below 1000 K at near atmospheric pressure were considered, constituting a network of 189 neutral reactions. The total number of species involved was 67. Thermodynamic data for species considered in the reaction mechanism were acquired from the GRI-Mech version 3.0 thermodynamics released on Jul. 30, 1999 and RMG thermodynamic libraries.

The software used for the microkinetic model was CHEMKIN-III. Electron impact reactions were imported into CHEMKIN as monomolecular reactions after multiplying the reaction rate constant as evaluated with BOLSIG+ with the electron density. In calculating reaction rate constants using the Boltzmann equation solver BOLSIG+, a steady state, uniform electric field, a negligible effect of super elastic collisions, temporal growth of electron production, and equal energy sharing after ionization were assumed. For E/N, nₑ and feed CH₄ concentration parametric studies, the reaction rate constants of electron impact reactions were modified accordingly. The reactor was modeled as an isothermal PFR-series of 100 CSTRs- and the reaction conditions were 1 atm pressure and 200 sccm gas flow rate.

### Analytical Methods and Sampling

The gas products were analyzed with inline gas chromatography (Agilent 7890B GC). The connecting lines from the reactor outlet to the GC inlet combined Tefzel (⅛″ OD, 0.093″ ID) and SS tubing (⅛″ OD, 0.028″ ID). The lag time between the reactor outlet and the GC inlet was about 4-16 s, depending on the total gas flow rate. The lines were heated with tape heaters to avoid condensation of gas products at a temperature of about 100° C., averaged by the measurements of four K thermocouple probes (TJC36 series, Omega) along the length of the lines. Samples were acquired after stabilization of the plasma discharge at about 18 min of operation. The sample was directed in two columns for analysis, an Agilent J&W HP-PLOT Q (30 m length, 0.53 mm ID, 40 μm thickness) connected to flame ionization detector (FID) and an Agilent J&W HP-PLOT Molesieve (30 m length, 0.53 mm ID, 25 μm thickness) connected to a thermal conductivity detector (TCD). The GC inlet connected to the HP-PLOT Q column was set at 300° C. temperature, 15 psi pressure, and 2:1 split ratio with He as the purge gas. The GC inlet connected to the HP-PLOT Molesieve column was set at 275° C. temperature, 5 psi pressure, and 5:1 split ratio with N₂ as the purge gas. The temperature program for product discretization was a 1.333 min retention at 40° C. followed by heating up to 250° C. with a ramp of 15° C./min and 2 min retention at 250° C. The temperature of the FID and the TCD was 280° C. and 250° C., respectively. FIG. 4 shows a typical chromatogram for these studies, featuring the C-based reactant and main products (CH₄, HCN, C₂-C₃ hydrocarbons, CH₃CN). Small amounts of CH₃CHCN, CH₂CHCN, C₄, and C₆H₆ were detected in certain experiments, but their concentrations were negligible compared to the other products. The reactant and product concentrations were evaluated using the response GC factor of each compound from calibration curves with gas standards.

### Plasma Stability and Outer Electrode Temperature Measurements

The plasma discharge depends on the reactor geometry and electrode characteristics. During experiments, the reactor configuration remained constant, but the conductivity of the outer and inner electrodes was altered. The temperature of the HV electrode rises with exposure time to high voltages, while both are susceptible to corrosion. To establish the timescale of electrode stability and thus, plasma discharge stability, the electrodes before and after plasma exposure over several experiments were observed. It was found that corrosion occurs rapidly during the first exposure (discoloration of metallic surfaces at first 5 min) and remains the same for subsequent experiments. Based on this observation, the same HV electrode was used for all studies and the ground electrode was cleaned with steel wool between each experimental set to retain the same starting point for all sets.

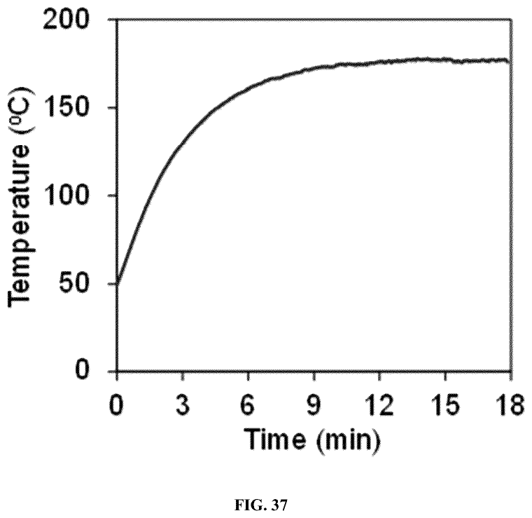

The temperature rise of the outer electrode was monitored with an IR camera (Optris XI 400 IR camera with a 7.5-13 μm thermal range, 80 mK resolution, with a macro lens f=20 mm/180×140 for working distances of 90-110 mm). The program used to record the temperature signal was Optris PIX Connect and the recording frequency was 5 s⁻¹. FIG. 37 shows a temperature profile of the HV electrode with plasma exposure time. The temperature values are not precise as the emissivity factor was approximated as that of oxidized brass (ε=0.5). However, since the example was interested in the relative change of temperature with time, the divergence from real temperature values was not substantial. The temperature of the outer electrode leveled off after about 10 min. Thus, sampling at 18 min of plasma operation ensures the stability of the plasma discharge.

### Experimental Measurements (Yield, E_{HCN}, P, C-Balance)

The instantaneous power required for full methane conversion is evaluated as:

$${P}_{theoretical} ( W ) = {F}_{{CH}_{4 , 0}} ( {E}_{{CH}_{4} , diss} + 0.5 \times {E}_{{N}_{2} , diss} ) \times 1 {0}^{3} \frac{J}{kJ}$$

$${CH}_{4} + 0.5 {N}_{2} \to HCN + 1.5 {H}_{2}$$

where F_{CH}_{_{4,0}} is the molar inflow of CH₄ in mol/s

$${E}_{{CH}_{4} , diss} = 868 \frac{kJ}{mol}$$

is the electron impact C—H bond dissociation energy of CH₄ (Reaction 1 in MS),

$${E}_{{N}_{2} , diss} = 940 \frac{kJ}{mol}$$

is the N≡N dissociation energy and the 0.5 factor is the stoichiometric coefficient of N₂ in R1. The discharge power for each experimental condition is estimated through the instantaneous voltage and current curves:

$$P = \frac{{\int }_{0}^{τ} V ( t ) \times I ( t ) dt}{τ}$$

where τ is the period of the sinusoidal discharge in s, V(t) is the instantaneous voltage in V and I(t) is the instantaneous current in A.

Methane conversion was evaluated according to Equation 1. Product selectivity, S_{X}, was evaluated according to Equation 2. The C balance was estimated as the sum of equivalent C concentrations of all measured compounds in the product stream to the CH₄ feed concentration (Equation 3). All remaining products (not measured by the GC) are coke and aromatic compounds deposited on the quartz tube wall (FIG. 1). The selectivity of CH₄ to coke and aromatic products, S_{coke}, was calculated according to Equation 4. The yield of a product, Y_{X}, was estimated from the conversion and selectivity Equation 5. The energy consumption, E_{HCN}, is the ratio of energy spent in the system per mmol HCN produced (Equation 6). The H balance was estimated as the sum of equivalent H concentrations of all measured compounds in the product stream to the CH₄ feed H concentration (Equation 7). The selectivity on hydrogen atom basis was calculated according to Equation 8.

$${x}_{{CH}_{4}} ( \% ) = \frac{{C}_{{CH}_{4 , 0}} - {C}_{{CH}_{4}}}{{C}_{{CH}_{4 , 0}}} \times 100 \% \qquad Equation 1$$

$${S}_{C , X} ( \% ) = \frac{{C}_{X} \times {N}_{{C}_{X}}}{{C}_{{CH}_{4 , 0}} - {C}_{{CH}_{4}}} \times 100 \% \qquad Equation 2$$

$$C balance ( \% ) = \frac{\sum {C}_{X , i} \times {N}_{{C}_{X , i}}}{{C}_{{CH}_{4 , 0}}} \times 1 \; 00 \% \qquad Equation 3$$

$${S}_{coke} ( \% ) = \frac{{C}_{{CH}_{4 , 0}} - \sum {C}_{X , i} \times {N}_{{C}_{X , i}}}{{C}_{{CH}_{4 , 0}} - {C}_{{CH}_{4}}} \times 1 \; 00 \% \qquad Equation 4$$

$${Y}_{X} ( \% ) = \frac{{x}_{{CH}_{4}} \times {S}_{x}}{100} \qquad Equation 5$$

$${E}_{HCN} ( \frac{kJ}{mmol HCN} ) = \frac{P}{Q \cdot {C}_{HCN}} \qquad Equation 6$$

$$H balance ( \% ) = \frac{\sum {C}_{X , i} \times {N}_{{H}_{X , i}}}{4 \times {C}_{{CH}_{4 , 0}}} \times 100 \% \qquad Equation 7$$

$${S}_{H , X} ( \% ) = \frac{{C}_{X} \times {N}_{{C}_{X}}}{4 ( {C}_{{CH}_{4 , 0}} - {C}_{{CH}_{4}} )} \times 100 \% \qquad Equation 8$$

Here x_{CH}_{₄} is the methane conversion, C_{CH}_{_{4,0}} is the feed CH₄ concentration in M, C_{CH}_{₄} is the concentration of CH₄ in the product stream in M, S_{C,X} is the selectivity on carbon atom basis of compound X,

$${C}_{X} = \frac{{C}_{X} ( \% )}{100} \times RT$$

is the concentration of compound X in M, C_{X} (%) is the volumetric percentage of compound X in the product stream evaluated from GC calibrations,

$$R = 0.082057 \frac{L \cdot atm}{mol \cdot K}$$

is the ideal gas constant, T=293 K is the temperature and N_{C}_{_{X}} is the number of carbon atoms in compound X. P is the discharge power in W, C_{HCN} is the concentration of HCN in M and Q is the total gas flow rate in L/s, N_{H}_{_{X}} is the number of hydrogen atoms in compound X and S_{H,X} is the selectivity on hydrogen atom basis of compound X.

The volume expansion factor, ε, based on product distribution is evaluated as:

$$ε = {y}_{{CH}_{4 , 0}} \times \frac{{x}_{{CH}_{4}} ( \% )}{100} \times \sum \frac{{S}_{X , i} ( \% )}{100} \times {δ}_{X , i}$$

where δ_{X,i} is the total molar change based on the stoichiometry per mol of CH₄ of formation reaction of product X, i. The products considered in this calculation are HCN, ethane, coke, acetonitrile, propionitrile, ethylene, acetylene, and propane:

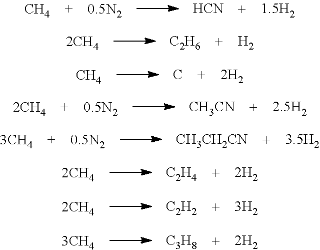

The total molar change for these reactions is δ_{HCN,1}=1.5+1−0.5−1=1,

$${δ}_{{C}_{2} {H}_{6} , 2} = \frac{1}{2} + \frac{1}{2} - 1 = 0 ,$$

and similarly, δ_{C,3}=2, δ_{CH}_{₃}_{CN,4}=0.5, δ_{CH}_{₃}_{CH}_{₂}_{CN,5}=0.33, δ_{C}_{₂}_{H}_{₄}_{,6}=0.5, δ_{C}_{₂}_{H}_{₂}_{,7}=1 and δ_{C}_{₃}_{H}_{₈}_{,8}=0.

Table 1 shows the ratio of the final to initial volumetric flow rate,

$$\frac{Q}{{Q}_{0}} ,$$

with the range of methane feed concentrations.

$$\frac{Q}{{Q}_{0}}$$

is evaluated as:

$$\frac{Q}{{Q}_{0}} = 1 + ε$$

The volume expansion is less than 2% for all experiments. Thus, it is considered negligible for the experimental conditions. The plasma residence time, t, was experimentally estimated based on the gas flow rate and reactor volume:

$$t = \frac{60 \cdot V}{Q}$$

where

$$V = \frac{π ( {d}_{o}^{2} - {d}_{i}^{2} )}{4} L = 1.57 {cm}^{3}$$

is the reactor volume, dₒ=0.7 cm is the outer reactor diameter, dᵢ=0.3 cm is the inner reactor diameter, L=5 cm is the reactor length defined by the outer electrode.

The standard deviation of energy consumption, σ_{E}_{_{HCN}}, is evaluated for each experimental data point as:

$${σ}_{{E}_{HCN}} ( \frac{kJ}{mmol HCN} ) = \frac{\sqrt{{P}^{2} {C}_{HCN}^{2} {σ}_{Q}^{2} + {P}^{2} {Q}^{2} {σ}_{{C}_{HCN}}^{2} + {Q}^{2} {C}_{HCN}^{2} {σ}_{P}^{2}}}{{C}_{HCN}^{2} {Q}^{2}} \times 1 {0}^{- 6}$$

Here σ_{Q} is the standard deviation of the flow rate (1% of the total flow rate) in L/s, σₚ is the standard deviation of the discharge power in W, σ_{C}_{_{HCN}} is the standard deviation of the concentration of HCN in mol/L and 10⁻⁶ is the conversion factor of J/mol to kJ/mmol.

### Reduced Electric Field and Electron Density Measurements

Experimental determination of the reduced electric field, E/N, of a filamentary plasma discharge, is challenging due to the short-lifetime and small dimensions of the streamers. In this example, however, there was interest in comparing E/N across different experimental conditions and acquiring a first approximation that can be generalized to the entire reactor volume for the microkinetic model. For the former, the method described by Mao et al. (X. Mao, Q. Chen, C. Guo, Methane pyrolysis with N2/Ar/He diluents in a repetitively-pulsed nanosecond discharge: Kinetics development for plasma assisted combustion and fuel reforming. Energy Convers Manag 200, 112018-112031 (2019)) was employed. The following equation was used to estimate E/N for the parametric studies of feed CH₄ concentration and plasma residence time:

$$\frac{E}{N} ( Td ) = \frac{\frac{U}{L + \frac{l}{ε}}}{{N}_{{N}_{2}}}$$

Where U is the peak applied voltage in V, L is the distance between the inner electrode and the quartz tube equal to 0.2 cm, l is the thickness of the dielectric layer (0.2 cm), ε is the relative permittivity of quartz equal to 4.3.

For the latter, E/N was estimated by the relative irradiance method, according to which the intensity ratio of N₂ (C-B, 0-0) emission at 337.1 nm and N₂⁺ (B-X, 0-0) emission at 391 nm is correlated with E/N through the following equation:

$$\frac{{I}_{{N}_{2}^{+} ( B - X , 0 - 0 )}}{{I}_{{N}_{2} ( C - B , 0 - 0 )}} = \frac{{k}_{{N}_{2}^{+} ( B )} \cdot {Q}_{{N}_{2}^{+} ( B )}}{{k}_{{N}_{2} ( C )} \cdot {Q}_{{N}_{2} ( C )}} = f ( \frac{E}{N} )$$

Where

$${I}_{{N}_{2}^{+} ( B - X , 0 - 0 )}$$

and I_{N}_{₂}_{(C-B, 0-0)} are the intensities of N₂⁺ (B-X, 0-0) and N₂ (C-B, 0-0) respectively,

$${k}_{{N}_{2}^{+} ( B )}$$

and k_{N}_{₂}_{(C)} are the direct electron impact excitation rates of formation of N₂⁺ (B) and N₂ (C) and are dependent on E/N,

$${Q}_{{N}_{2}^{+} ( B )} = \frac{{A}^{{N}_{2}^{+} ( B - X , 0 - 0 )}}{{A}^{{N}_{2}^{+} ( B - X , 0 - 0 )} + {k}_{q , {N}_{2}}^{{N}_{2}^{+} ( B )} \cdot {N}_{{N}_{2}}} and$$

$${Q}_{{N}_{2} ( C )} = \frac{{A}^{{N}_{2} ( C - B , 0 - 0 )}}{{A}^{{N}_{2} ( C - B , 0 - 0 )} + {k}_{q , {N}_{2}}^{{N}_{2} ( C )} \cdot {N}_{{N}_{2}}}$$

are the quenching factors of N₂⁺ (B) and N₂ (C),

$${A}^{{N}_{2}^{+} ( B - X , 0 - 0 )}$$

and A^{N}^{₂}^{(C-B, 0-0)} are the Einstein coefficients of N₂⁺ (B-X, 0-0) and N₂ (C-B, 0-0) in s⁻¹,

$${k}_{q , {N}_{2}}^{{N}_{2}^{+} ( B )} and {k}_{q , {N}_{2}}^{{N}_{2} ( C )}$$

are the quenching rate constants of N₂⁺ (B-X, 0-0) and N₂ (C-B, 0-0) with N₂ molecules in cm³/s and N_{N}_{₂} is the N₂ density in cm⁻³. The rates of formation

$${k}_{{N}_{2}^{+} ( B )}$$

and k_{N}_{₂}_{(C)} were estimated by BOLSIG+ version 12/2019, using cross sectional data from the Phelps database, retrieved on Mar. 1, 2023.

$${A}^{{N}_{2}^{+} ( B - X , 0 - 0 )}$$

and A^{N}^{₂}^{(C-B, 0-0)} were set equal to 1.14×10⁷ s⁻¹ and 1.31×10⁷ s⁻¹ respectively(56),

$${k}_{q , {N}_{2}}^{{N}_{2}^{+} ( B )} and {k}_{q , {N}_{2}}^{{N}_{2} ( C )}$$

equal to

$$8.84 \times 1 {0}^{- 10} \frac{{cm}^{3}}{s} and {10}^{- 11} \frac{{cm}^{3}}{s}$$

respectively(55, 57) and N_{N}_{₂} was estimated from the ideal gas law for P=1 atm and T=550 K.

FIG. 18 shows the ratio of nitrogen emissions for a range of E/N (100-500 Td). The curve (diamond points) remains the same over a range of electron densities (10⁹-10¹³ cm⁻³). The experimental value, which was measured by considering the area of the two peaks as acquired by optical emission spectroscopy, corresponds to an E/N=435 Td. This value is used as a focal point for the microkinetic model.

The electron density, nₑ, was estimated through the current density, j, and electron drift velocity, u_{d}, based on the following equation:

$${n}_{e} ( {cm}^{- 3} ) = \frac{j}{e \cdot {u}_{d}}$$

Assuming a homogeneous plasma volume between the quartz tube and the inner electrode, the current density was approximated based on the equation:

$$j ( \frac{A}{{cm}^{2}} ) = \frac{\overline{I}}{{A}_{p l a s m a}}$$

Where e is the electron charge equal to 1.602×10⁻¹⁹ C,

$$\overline{I} ( A ) = \frac{{\int }_{t}^{t + T / 2} I ( t ) dt}{T / 2}$$

is the average current density evaluated as 2.66×10⁻³ A, T=4.54×10⁻² ms is the period of the sinusoidal discharge and

$${A}_{plasma} ( {cm}^{2} ) = \frac{π ( {a}_{quartz}^{2} - {a}_{electrode}^{2} )}{4}$$

is the estimated plasma cross sectional area equal to 3.14×10⁻¹ cm², d_{quartz} is the ID of the quartz tube in cm and d_{electrode} is the diameter of the inner electrode in cm. The current density was evaluated at

$$4.07 \times 1 {0}^{2} \frac{A}{{m}^{2}} .$$

The drift velocity was estimated by BOLSIG+ for E/N=435 Td, equal to

$$3.46 \times 1 {0}^{7} \frac{c m}{s} .$$

The resulting electron density was 7.3×10⁹ cm⁻³.

### Effect of Discharge Power

FIG. 13 shows the effect of the discharge power, P, ranging from 26 to 39.3 W, on product distribution, conversion and HCN energy consumption for C_{CH4,0}=1% and 0.47 s residence time. While product distribution is not affected by discharge power, HCN selectivity exhibits a linear dependence on P, with the highest Y_{HCN}=50.8% observed at 39.3 W. E_{HCN} remains relatively constant with discharge power, at about

$$51 \frac{kJ}{mmol} ,$$

which is anticipated considering the linear behavior of Y_{HCN} with P.

Increasing the discharge power appears to favor HCN selectivity without negatively affecting energy consumption. This indicates a potential correlation between the fraction of e⁻ with higher energies and HCN selectivity, i.e., increasing the percentage of e⁻ with energies over a certain threshold and/or increasing the upper energy limit accessed by those e⁻, results in more intensified HCN production.

### MKM Parametric Studies (E/N, ne, Tg)

To select the residence time of the model that best captures the experimental data, least squares regression for HCN and C₂H₆ yield was used. To ascertain the optimal model conditions to experimental data in terms of E/N, nₑ and T_{g}, a combination of least squares for HCN yield and faithfulness to HCN and C₂H₆ experimental trends was utilized as guidelines.

To determine the optimal MKM input conditions, i.e., the E/N, T_{g} and electron density (nₑ) values that best represent experimental results, a parametric study was conducted using experimental estimations as focal points. FIG. 11, FIG. 12 and FIG. 14 show the effect of reduced electric field, ranging from 150-500 Td, on product distribution and CH₄ conversion for the investigated feed concentration range (0.1-7%). The experimental results are shown in FIG. 15 for reference. The condition that simulates yield trends of HCN and C₂H₆ most faithfully appears to be E/N=300 Td.

FIG. 13 depict the effect of electron density, ranging from 10⁹-10¹³ cm⁻³, on product distribution and CH₄ conversion for the investigated feed concentration range (0.1-7%). The only condition able to closely reproduce HCN and C₂H₆ yield trends with C_{CH}_{₄}_{,0} is nₑ=10¹¹ cm⁻³. FIG. 15 displays the effect of gas temperature, ranging from 450-700 K, on product distribution and CH₄ conversion for the investigated feed concentration range (0.1-7%). Similarly, the condition that captures HCN and C₂H₆ yield trends most faithfully is T_{g}=550 K, which corresponds to the experimental temperature measurement.

### MKM Results—Longer Residence Time

FIG. 16 displays the evolution of HCN yield with residence time as predicted by the MKM for C_{CH}_{₄}_{,0}=1% and for C_{CH}_{₄}_{,0} from 0.1 to 7%, correspondingly. HCN yield reaches a steady state after about 20 ms, indicating an upper limit for each C_{CH}_{₄}_{,0}. At longer residence times, the highest to lowest Y_{HCN} are predicted from 0.1-7% C_{CH}_{₄}_{,0} correspondingly, with 2-7% C_{CH}_{₄}_{,0} exhibiting a similar upper limit.

### Number of Microdischarges Per Discharge Cycle Evaluation

The volume of the plasma streamers, corresponding to 0.3% of the reactor, is equivalent to 4.2 mm³. For a typical filament diameter of 100 μm, the number of microdischarges per discharge cycle is about 67, which was calculated from the following equation:

$${N}_{MD} = \frac{π \cdot {d}_{f}^{2} \cdot {l}_{f}}{{V}_{plasma}}$$

where N_{MD} is the number of microdischarges per discharge cycle, d_{f}=0.1 mm is the filament diameter, l_{f}=2 mm is the filament length and Vₚₗₐₛₘₐ=4.2 mm³. The number of microdischarges during one period is in agreement with literature of DBD systems with similar applied voltage and frequency.

### EHCN and Energy Efficiency Evaluation

The total energy consumption, E_{HCN}, of reported processes is calculated from the following equation and is evaluated considering the energy cost of the process and NH₃ production (for processes using an NH₃ feedstock):

$${E}_{HCN} ( \frac{kJ}{mmol HCN} ) = {E}_{HCN , process} + {E}_{HCN , {NH}_{3}}$$

E_{HCN,process} is equal to

$$31 \frac{MJ}{kg HCN} = 0.84 \frac{kJ}{mmol HCN}$$

for the BMA process,

$$5. 43 \frac{kJ}{mmol HCN}$$

for the Invista process and

$$5.2 \frac{kJ}{mmol HCN}$$

for the NH₃/CH₄ plasma. E_{HCN,NH}_{₃} is equal to 33 GJ/ton NH₃ produced for processes using NH₃ as a feedstock, i.e., BMA, Invista and NH₃/CH₄ plasma processes, and equal to 0 for this work. Separation and purification costs are not included in E_{HCN,process} for any process.

The energy efficiency, η, of the plasma process is defined as the ratio of the energy consumed by chemical transformations, gas heating and plasma dissociation of the reactants:

$$η ( \% ) = \frac{\begin{matrix}\sum {v}_{i} {η}_{i} ( {H}_{{f}_{i , 298 K}} + {\int }_{298}^{550} {C}_{{p}_{i}} ( T ) d T ) + \dot{{m}_{{N}_{2}}} {\int }_{298}^{550} {C}_{{p}_{{N}_{2}}} ( T ) dT + \\ \dot{{m}_{C {H}_{4}}} {\int }_{298}^{550} {C}_{{p}_{C {H}_{4}}} ( T ) d T + ( {E}_{C {H}_{4}} + \frac{{E}_{{N}_{2}}}{2} ) Q {C}_{H C N}\end{matrix}}{P} \times 100 \%$$

where vᵢ is the production/consumption coefficient (negative for reactants, positive for products), nᵢ=Cᵢ×Q is the molar amount of consumed reactant or generated product i in mol/s, Cᵢ is the concentration of product i in mol/L, Q is the flow rate in L/s, H_{f}_{_{i,298}} is the enthalpy of formation of compound i (CH₄, N₂, HCN, C₂H₆, CH₃CN and C₃H₈) at 298 K in J/mol (61-64), Cₚ_{ᵢ}(T) is the heat capacity of gas i in J·mol⁻¹·K⁻¹, m·_{N}_{₂} and m_{CH}_{₄} is the feed mass flux of N₂ and CH₄, respectively, in kg/s,

$${C}_{{p}_{{N}_{2}}} ( T ) and {C}_{{p}_{C {H}_{4}}} ( T )$$

is the gas heat capacity of N₂ and CH₄, respectively in J/kg/K, C_{HCN} is HCN concentration in M and P is the measured discharge power in W. The first term in the numerator is the heat rate in converting reactants to products at 550 K.

The CO₂ equivalent emissions incurred by NH₃ as a feedstock are estimated as:

$${CO}_{2 , {NH}_{3}} ( \frac{kg {CO}_{2}}{kg HCN} ) = \frac{{F}_{{CO}_{2} , {NH}_{3}} \times \frac{{M}_{{NH}_{3}}}{{M}_{HCN}}}{ε} = \frac{2.11 \times \frac{17.03}{27.03}}{0.85} = 1.5$$

Where F_{CO}_{₂}_{,NH}_{₃} is the CO₂ equivalent emission factor of NH₃ equal to

$$2.11 \frac{kg {CO}_{2}}{kg {NH}_{3}} , {M}_{{NH}_{3}} = 17.03 \frac{g}{mol}$$

is the molecular weight of NH₃,

$${M}_{HCN} = 27.03 \frac{g}{mol}$$

is the molecular weight of HCN and ε is the average conversion efficiency of NH₃ to HCN for industrial processes equal to 0.85.

### HCN Separation and Purification Comparison

In the BMA process, the product stream separation and purification include an ammonium sulfate absorber and a crystallizer, a hydrogen cyanide stripper, an HCN absorber, an HCN distillation column and a sodium cyanide absorber. These amount to an energy cost of 5.47 MJ/kg HCN recovered.

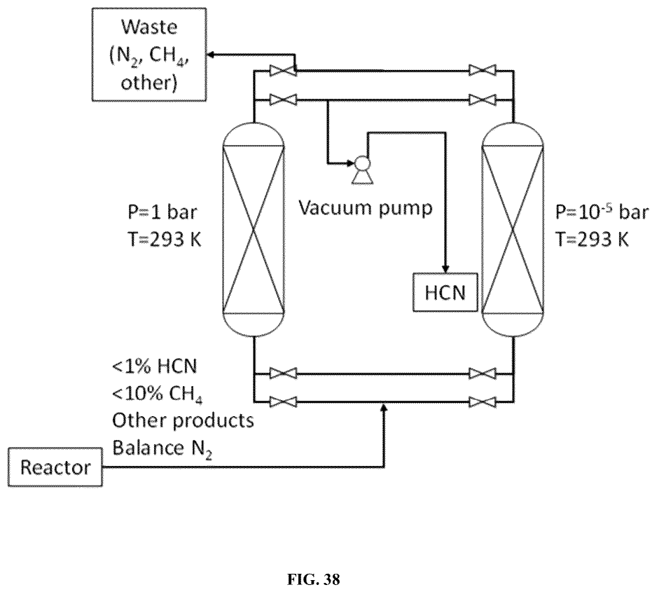

The product stream of the N₂/CH₄ plasma reactor has an HCN concentration of 0.05 to 0.5 wt %, which allows the use of zeolite adsorption beds. FIG. 38 proposes a two-bed vacuum swing adsorption (VPSA) scheme for the recovery of pure HCN from a dilute stream. The reactor product stream flows into the zeolite-packed adsorption column at ambient temperature and pressure. After adsorption is complete, the inflow and outflow valves are shut off and the vacuum pump is turned on. HCN desorption occurs at reduced pressure and pure HCN is collected at the outlet of the pump.

The most energy intensive component in this process is the operation of the vacuum pump. It is assumed that the energy consumption of HCN recovery is equal to the energy required by the pump to reach medium vacuum (about 10⁻⁵ bar), E_{pump down}, and the energy to maintain it during desorption, E_{desorption} is calculated from the following equation:

$$E ( kJ ) = {E}_{pump down} + {E}_{d esorption}$$

To estimate the cost of this operation, available adsorption-desorption data of mordenite packed beds and technical data of an Edwards EDS480 vacuum pump were used. For a packed column of 3.5 m³ total volume, 80% of which is occupied by the bed, the amount of HCN adsorbed per cycle is estimated at about 408 kg HCN according to Equation 9.

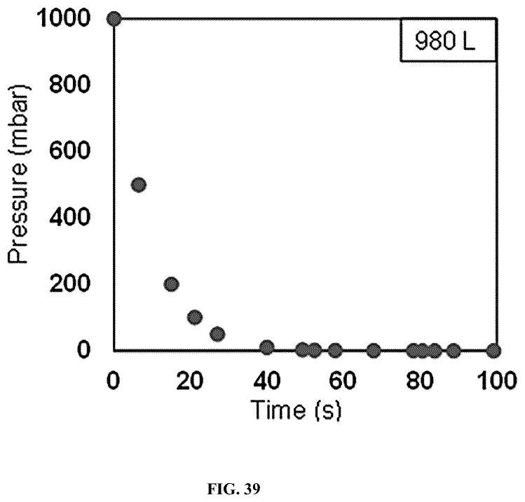

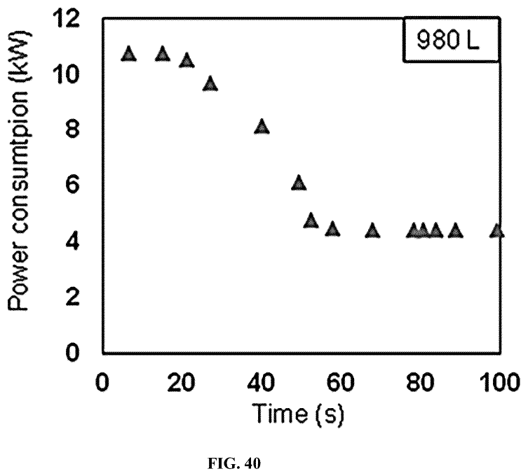

To evaluate the energy required by the pump to reach medium about 10⁻⁵ bar, the evacuation time, t_{evac}, was estimated based on the pumping speed curve (Equation 10). FIG. 39 and FIG. 40 show the resulting pump down graph and power consumption-evacuation time graph, respectively, for a gas volume of 980 L. E_{pump down} is approximated from the area under the power consumption-evacuation time graph (Equation 11) to be about 612 kJ. E_{desorption}, estimated for desorption times between 2 and 30 min (Equation 12), ranges from 532 kJ to 16 MJ. The total HCN energy consumption for this separation process is estimated between 3.3 to 140 kJ/kg HCN (Equation 13).

HCN purity at the pump outlet is evaluated according to Equation 14 at about 99.7 wt %. It is assumed that the only impurities originate from leftover gas in the bed void fraction during adsorption, which for simplification is considered mostly N₂. By introducing a separation process compatible with the low HCN concentration in the product stream, separation and purification costs were reduced by at least 97%.

$${m}_{HCN , ads} ( kg HCN ) = \frac{f \cdot {X}_{HCN} \times {V}_{b e d} \times {ρ}_{mordenite}}{1000 \frac{g HCN}{kg HCN}} \qquad Equation 9$$

$${t}_{e v a c} ( s ) = \frac{{V}_{g a s}}{q} \times ln ( \frac{{P}_{1}}{{P}_{2}} ) \qquad Equation 10$$

$${E}_{pump down} ( kJ ) = \frac{{\int }_{0}^{100} ( {P}_{w} \times {t}_{e v a c} ) dt}{100} ≅ \sum {P}_{w , i} \times Δ {t}_{e v a c , i} \qquad Equation 11$$

$${E}_{d esorption} ( kJ ) = {P}_{w} ( @ {10}^{- 5} atm ) \times {t}_{desorption} \times 60 \frac{s}{min} \qquad Equation 12$$

$${E}_{H C N} ( \frac{k J}{k g} ) = \frac{{E}_{pump down} + {E}_{desorption}}{r \times {m}_{HCN , ads}} \qquad Equation 13$$

$$wt \% HCN = \frac{r \times {m}_{H CN , ads} \times 1 {0}^{3} \frac{g}{k g}}{( r \times {m}_{H CN , ads} + \frac{{M}_{{N}_{2}} {P}_{ads} {V}_{gas}}{R T} )} \qquad Equation 14$$

where

$${X}_{H C N} ( \frac{mg HCN}{g mordenite} ) = 76$$

is the maximum HCN loading on mordenite at ambient temperature and pressure, f is the fraction of the loading of the beds at the end of the adsorption step (assumed equal to 0.9), V_{bed}=0.8*3.5 m³=2.8 m³,

$${ρ}_{mordenite} = 2130 \frac{k g}{{m}^{3}} ,$$

V_{gas}=ε×V_{bed} is the void volume in the bed occupied by gas, t_{evac} is the evacuation time (time required to reach P₂ from P₁), ε=0.35 is the void fraction of the bed,

$$q ( \frac{{m}^{3}}{s} )$$

is average pumping speed for ΔP=P₁−P₂, P₁ (mbar) is the starting pressure, P₂ (mbar) is the final pressure, P_{w}(kW) is the power consumption, t_{desorption} (min) is the duration of the desorption process, which ranges from 2 to 30 min and r=0.85 is fraction of adsorbed HCN recovered.

$${M}_{{N}_{2}} = 28 \frac{g}{mol}$$

is the molar mass of N₂, P_{ads}=1 bar is the pressure during adsorption,

$$R = 0.08 \; 2057 \frac{L \cdot atm}{K \cdot mol}$$

is the ideal gas constant and T=293 K is adsorption temperature.

### Optical Emission Spectroscopy Measurements

The optical fiber was positioned above the outer electrode and close to the quartz tube to capture the plasma glow. The acquired wavelength range was 200-1100 nm, with a resolution of 0.5-0.7 nm. The spectra were analyzed with the Avasoft software. The peaks of interest for this system are primarily between 300-450 nm (FIG. 33). The vibrational bands of the second positive system (SPS) of N₂ (C-B) from 310-380 nm are dominant, which is expected for a N₂/CH₄ DBD plasma with a concentration ratio of 13-1000, i.e., N₂ rich plasma. It is interesting to note that the first negative system (FNS) of N₂⁺ (B-X, 0-0) peak at 391 nm exhibits a much smaller intensity compared to the characteristic vibrational N₂ peak (C-B, 0-0), indicating that the population of ionized species is almost negligible compared to that of vibrationally excited species. The vibrational bands of CN* and CH* are also observed.

### MKM Equations

The novel plasma modelling approach compared to existing methods is summarized in FIG. 36. Current methods recursively update species densities and, thus, rates of electron impact reactions at every time step, while the modeling approach pursued in this example evaluates these rates once under E/N and nₑ stead state assumption. The effect of gas composition change at each time step is considered negligible for N₂ rich conditions. The experimental system was modeled as a plug flow reactor (PFR) model, which in CHEMKIN is processed as a series of CSTRs, while in existing models, plasma reactors are modelled as batch systems. For electron impact reactions, where electrons are one of the reactants, a pseudo-monomolecular reaction rate constant is defined to include nₑ (see the following equation):

$${k}_{i}^{′} = {k}_{i} {n}_{e}$$

Where kᵢ′ is the pseudo-monomolecular rate constant of reaction i in s⁻¹ and kᵢ is the rate constant in L·mol⁻¹s⁻¹.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A method for synthesizing hydrogen cyanide, the method comprising:
generating a plasma discharge zone inside a dielectric barrier discharge (DBD) reactor; wherein the DBD reactor does not contain a catalyst;
adding a gas mixture containing methane gas and nitrogen gas into the DBD reactor;
dissociating the methane gas into methyl radicals and the nitrogen gas into nitrogen radicals in the reaction zone of the DBD reactor; and
synthesizing hydrogen cyanide from the methyl radicals and the nitrogen radicals in the reaction zone of the DBD reactor.

2. The method of claim 1, wherein generating the plasma discharge zone inside the DBD reactor comprises:
generating a frequency with an alternating current (AC) power supply between a high voltage electrode and a grounding electrode.

3. The method of claim 2, wherein the frequency is 22 kHz.

4. The method of claim 2, wherein the AC power supply provides a discharge power between 25 to 40 W.

5. The method of claim 1, wherein the gas mixture containing methane gas and nitrogen gas is premixed with a nitrogen gas containing 99.99% N₂ before being added into the plasma discharge zone inside the DBD reactor.

6. The method of claim 1, wherein the gas mixture containing methane gas and nitrogen gas possesses methane at a concentration ranging from 0.1 to 7.0 wt % based on the total weight of the gas mixture.

7. The method of claim 1, wherein forming hydrogen cyanide gas from the methyl radicals and the nitrogen radicals in the plasma discharge zone inside the DBD reactor occurs at a temperature ranging from 25° C. to 300° C.

8. The method of claim 1, wherein the gas mixture containing methane gas and nitrogen gas resides in the plasma discharge zone of the DBD reactor for a time ranging from 0.5 to 1.9 seconds.

9. The method of claim 1, wherein dissociating the methane gas into methyl radicals comprises:
forming one or more intermediate methyl radical species selected from the group consisting of ·CH₃ and ·CH₂.

10. The method of claim 1, wherein dissociating the nitrogen gas into nitrogen radicals comprises:
forming one or more intermediate nitrogen radical species selected from the group consisting of ·N, ·NH, ·HCNH and ·H₂CN.

11. The method of claim 1, wherein generating the plasma discharge inside the plasma discharge zone of the DBD reactor comprises one or more of the following:
generating a reduced electric field of 300 Td in the plasma discharge zone;
generating a discharge power of 25 to 40 W in the plasma discharge zone;
maintaining a temperature of 300° C. in the plasma discharge zone; or
achieving an electron density of 10¹¹ cm⁻³ in the plasma discharge zone.

12. The method of claim 1, wherein synthesizing hydrogen cyanide from the methyl radicals and the nitrogen radicals in the plasma discharge zone inside the DBD reactor requires an energy of consumption of at least 45 kJ/mmol of hydrogen cyanide.

13. The method of claim 1, wherein the method has a lower bound of 0.2 kg of CO₂ equivalent emissions per kilogram of hydrogen cyanide synthesized.

14. A system for synthesizing hydrogen cyanide, the system comprising:
a first storage compartment configured to store nitrogen gas;
a second storage compartment configured to store a gas mixture containing methane gas and nitrogen gas;
a mixer configured to receive and mix together a stream of nitrogen gas from the first storage compartment and a stream of the gas mixture from the second storage compartment; and
a plasma reactor in communication with the mixer.

15. The system of claim 14, wherein the plasma reactor possesses a plasma discharge zone between a high voltage electrode and a grounding electrode separated by a quartz dielectric barrier.

16. The system of claim 14, comprising:
an oscilloscope, a high voltage probe in communication with a high voltage electrode, and a high voltage power supply.

17. The system of claim 14, comprising:
a current probe in communication with a grounding electrode and an oscilloscope.

18. The system of claim 14, comprising:
a temperature reader in communication with the plasma reactor.

19. The system of claim 14, comprising:
an export line in communication with the plasma reactor, the export line being configured to transport gaseous products to a vent or a gas chromatographer.

20. The system of claim 19, wherein the export line is coated with tape heaters to avoid condensation of the gaseous products.

21. The system of claim 19, wherein the export line comprises a pressure gauge.
